(19) United States
(12) Patent Application Publication
(10) Pub. No.: US 2019/0286990 A1
(43) Pub. Date: Sep. 19, 2019

(54) Deep Learning Apparatus and Method for Predictive Analysis, Classification, and Feature Detection

(71) Applicant: AI Certain, Inc., Richmond, VT (US)

(72) Inventors: Timothy Paul Kenney, Richmond, VT (US); Nathaniel James Kenney, Bozeman, MT (US)

(21) Appl. No.: 15/924,845

(22) Filed: Mar. 19, 2018

(51) Int. Cl. G06N 3/08; G06N 3/04

(52) U.S. Cl. CPC G06N 3/084; G06N 3/04

(57) ABSTRACT

A deep learning computer apparatus and corresponding methods render multiple disparate data type items, along with corresponding feature data, into a single encapsulated file format for neural network processing. Processing overhead is reduced by allowing otherwise disparate data elements to be trained and processed together as a single item in a single processing pass, thereby increasing effective neural processor capacity.

### BACKGROUND

### 1. Technical Field

This disclosure relates generally to deep learning computing systems and, more specifically, to computer apparatus and methods for rendering multiple disparate data types into a single encapsulated file format compatible with deep learning classification.

### 2. Background Information

Deep learning neural networks are machine-based systems that utilize several layers of connected artificial neurons. The outputs of the highest layers are constructed using data outputs from lower layers to compute an outcome, e.g., classification, feature detection, ranking, or action. Traditional systems and methods exist and are well known for machine learning/deep learning neural nets that are trained by example and subsequently automate classification of objects from images and/or data. These systems classify or identify one or more objects or areas of interest within the image or data based on known algorithms for training machine learning systems such as deep learning neural nets. The neural network or machine learning algorithm is fed a series of images or organized data results to “train” the system. Training the system involves adjusting an algorithm using a method such as gradient descent or in neural networks using back propagation to adjust weights and biases in some configuration of neural network input, hidden layer and output layer. The unique nodes in a final, or output, layer represent the different classifications of the image and are presented with a probability or confidence factor. Typically, these systems select the top probability or confidence factor as the classification of the image or data. Current systems and methods are limited in their ability to combine image, video and sound data with other data types for use by the deep learning neural networks. Current deep learning neural network systems are limited in their ability to deal with sets of actions articles or events with combined situational information.

A major challenge for real-world automated machine-based decision making is real-time or near real-time ranking of one or more articles, actions, or events from a set of possible articles, actions or events using current real-world situational information. Data exists for each possible article, action or event as well as data for the current situation. The data may include qualitative, quantitative, image, sound, and video data. Existing systems and methods are unable to combine multiple disparate data sources into one usable form for timely analysis by a single neural net.

A further complexity presented by real-world situations is the problem of missing data and changes in data magnitude. It is difficult to utilize traditional machine learning and algorithmic systems when data is missing in training or in the prediction phase. Traditional solutions for missing data involve using empty or zero values may accidentally drive the algorithm to an incorrect output. Similarly, data magnitude changes may also drive the system to incorrect output.

Solving the complexity of prediction or decision making when dealing with disparate data types has typically involved utilizing many different models that include multiple machine-learning systems, writing code to perform decision trees or rule-based systems, or complex statistical modeling and combinations across the various input data types and data sets. Combining multiple algorithmically generated analyses, including disparate neural nets, of different data types and sets is very challenging. Such systems require an additional aggregator algorithm to formulaically combine these analyses into a single output. In order for the system to select the correct set of zero or more choices it needs to order or rank the choices based on a desired outcome and compute a confidence factor for each outcome.

Tuning and testing a complex multi-algorithmic system for real world operation is a major challenge. Tuning any single algorithm's use of a unique data value input typically requires accounting for all combinations of other data elements and algorithms. In a system utilizing a substantial volume of data and algorithms applying test cases for all possible combinations of said data is not feasible due to the immense number of combinations. The number of possible ordered decisions from N items or actions is N! (N factorial) in computation. Ten possible items or actions that must be ordered represents 3,628,880 possible combinations of training examples. Twenty possible items or actions represents more than 2.4×10¹⁸ combinations of training examples. Predicting the 4 best items or actions from a set of 1000 items or actions requires 9.9×10¹¹ possible combinations to be evaluated. This becomes an intractable problem to solve as the number of items or actions becomes large. It is worthwhile to reduce the complexity of such systems and reduce the computational complexities to allow for real-time deep learning networks on minimal computer hardware like home computers, smartphones or embedded control hardware.

Accordingly, it would be desirable to have a computer architecture that efficiently analyzes multiple disparate data types using a single neural net, and to configure and adapt such a system to efficiently perform predictive analysis, classification, feature detection, ranking, and subsequent action.

### 3. SUMMARY

The disclosed subject matter herein provides methods and systems for the integration of multiple disparate data types into a single data type to be used for the training and implementation of deep learning neural networks that are capable of predictive analysis across a set of articles, actions and events. Embodiments described herein are capable of performing predictive analysis, ranking, or classification among a set of possible items/actions and situational information with reduced computational complexity compared with other methods, thereby providing an improved computing system that allows for real-time decision making in problem domains that otherwise required more complex and expensive equipment.

Embodiments disclosed herein include computer systems and corresponding computer programs recorded on a storage device configured to perform the methods. In various embodiments, computer systems and computer programs are configured to perform a series of instructions on input data to cause the apparatus to complete the steps necessary to perform the method. It is understood that embodiments disclosed herein, and portions thereof, are implemented with computer system circuitry and with and upon data stored within said computer system.

In one aspect, a method and system is given for a deep learning neural network where an image, video or sound of an article, action or event is combined with qualitative and quantitative data about said article, action or event, creating a single encapsulated data type that can be used to train a neural network to perform automated predictive analysis, classification, feature detection, ranking, and subsequent action. This embodiment has several advantages over existing systems and methods including simplification of the steps for training and prediction, reduced computational steps, reduced computational capacity, and increased accuracy.

Encapsulating the disparate data types into a single data type involves several steps, including collection of metadata for the image, video or sound data. Image information includes image width, height, bit depth, number of channels (e.g. 3 for R,G,B), byte orders, and expected ranges. Video information includes sample times and sample byte size where sample byte size is determined by things like interlacing, pixels per frame, frame resolution, pixel depth, bits per pixel, and information about the video's sound data. Sound data includes sample times and sample size where sample size is determined by things like sampling rate, number of channels (e.g. 2 for stereo), and bit depth and expected ranges. Maximum and minimum values are used for each value in order to correctly expand the underlying data without losing the core integrity of the video, image or sound. Insertion of the new encoded qualitative and quantitative data should fall within expected ranges. These encoded values will henceforth be referred to as features.

Before insertion of the encoded features into the image, video or sound, each data element in feature set(X) is numerically encoded and scaled within expected ranges of the image, video or sound format. In one embodiment this is accomplished by analyzing the range of all known samples of the specific data element X and performing a rescaling of that data to fit within the range of the image, video or sound format.

An expanded size for the image, video or sound file is determined by computing the number of bits to represent the features to be inserted. The expansion of the underlying format is done so that the image, video or sound data is not disrupted. In one embodiment, images are expanded to a new height of height+H so that the existing image is relocated in its entirety, shifted by H. In another embodiment, this is done by width. Video and sound are expanded by inserting S samples of video or sound of sample time, x, such that this is larger than the byte size of the features to be inserted. Inserted data is padded with zero or null values to insure the existing image, video or sound is preserved and shifted by S samples. This allows well known algorithms for analyzing image, sound or video to be effective at analyzing the new single encapsulated data type. Finally the scaled features are inserted into the image, sound or video and padded with null or zero data to shift the existing image, video or sound.

Training a neural net with a set of the singular encapsulated data type involves pairing the singular encapsulated data type with optimal outputs and updating the values of the parameters of the neural network to minimize a loss function. This is accomplished through an iterative series of computations known as back-propagation and a training technique (e.g. Stochastic Gradient Descent, Adam Optimizer or other known training technique). The backpropagation is accomplished by computing an error for each layer starting with the output layer and adjusting parameters for each layer below to minimize the loss. The neural network is training to accurately determine the correct outputs for any given singular encapsulated data type. In various embodiment for different applications, the neural network type is, for example, a feed forward neural network, a convolutional neural network, or a modular neural network. The combination of multiple machine learning algorithms into one training step not only simplifies the process by removing tuning between disparate machine learning systems dealing with the data in different algorithms but increases accuracy as it allows the neural network to weight image, video or sound attributes directly against features in the same network.

The trained neural network can now be used to perform automated predictive analysis, classification, feature detection, ranking, and initiate subsequent action when presented with an unknown singular encapsulated data instance. The unknown singular encapsulated data instance is assembled by combining an image, video or sound with accompanying features about said article action or event and features about the situation or environment following the steps outlined above for training the neural network. Features are numerically encoded and scaled to fit correctly with the image, video or sound. The video, image or sound is expanded, and features are inserted. The resulting singular encapsulated data type is presented to the neural network for a feed-forward computation of outputs. At each level of the neural network values are computed for each neuron based on weights and biases for each input. The resulting output is then passed to the next level of the network as the input for that level. The final layer of the neural network computes a probability, sometimes called a confidence factor for each possible output based on the output values of the layer below it. Outputs represent categorization, feature detection, ranking, subsequent action or some other computable value. The advantage of this feed-forward step with encapsulated data (i.e. containing image, video, sound and features) over traditional methods and systems is the simplification of many machine learning algorithms into one neural network. This decreases the required computational power and increases the computational speed allowing for real-time feedback or action on smaller computational devices.

Other detailed embodiments using the advantages of the single encapsulated data type with a deep learning neural network are supplied in the detailed description and include advantages in medical diagnosis from an image with medical record information, weather prediction and radiographic security systems.

In another embodiment, a method and system are given where multiple single encapsulated data types representing unique members from a set of articles, actions or events are combined with feature data about the situation or environment to create a single multi-set encapsulated data type. This multi-set encapsulated data type is then used to train a neural network to perform automated predictive analysis, classification, feature detection, ranking, and subsequent action relative to the set of articles, actions or events that are presented. This system and method requires the set of articles, actions or events to be related in some aspect, such as, attempting to attain a common shared outcome, utilizing a limited resource, or the members of the set interact in one or more ways among shared features. The system automatically adjusts the deep learning neural network to be able to predict outcomes from and within the combined set.

Single encapsulated data types for each article, action or event (member) in the set are created as per the prior embodiment. The encapsulated data for each member of the set is appended together to form a representation that still fits within the acceptable parameters of the underlying expanded image, video or sound format. Environmental or situational features can be included within each member's single encapsulated data type.

Alternatively, environmental or situational data may be merged by extending the new single multi-set encapsulated data type. Said data are scaled to fit within the boundaries of the single encapsulated data types for the members of the set. Before insertion of the features into the encapsulated multi-set data, the features are numerically encoded and scaled within expected ranges of the image, video or sound format. In some embodiments, this is accomplished by analyzing the range of all known samples of the specific data element X and performing a rescaling of the data to fit within the range of the image, video or sound format (as mentioned above).

An expanded size for the encapsulated multi-set image, video or sound file is determined by computing the number of bits to represent the features to be inserted. The expansion of the underlying format is done so that the image, video or sound data is not disrupted. The combined images of all set members are expanded to a new width(W)+W_{expanded} so that each existing singular encapsulated data element remains in its original location and additional data is added by expanding the image by W_{expanded} over the entire width of the encapsulated data type. In another embodiment, this is done by height.

Video and sound can be expanded in two different ways depending on whether the inserted data is relevant to the time sampling or relevant to the entire video or sound sample. For example, the speed of an autonomous vehicle should be included with a video frameset, as it can change with different frames. In contrast, the age of patient at the time of a sonogram in a medical video is not frame dependent and does not change during the video. Features that are not frame dependent may be added by inserting S samples of video or sound of sample time, x, such that this is larger than the byte size of the feature to be inserted. Therefore, the existing singular encapsulated data elements are preserved and shifted by S samples. Inserted data is padded with zero or null values to insure the existing image, video or sound is preserved and shifted by S samples. Information that is frame (time dependent) may be added by expanding the images in the video feed or adding frequency ranges to the sampled sound which leaves the underlying video or sound intact.

Missing data from any member of the multi-set encapsulated data type can be generated and inserted before training or prediction. Filling missing data with null or zero is not optimal as the neural net will assume it is the actual value and it may lead to less than optimal outcomes. There are several methods for generating missing (or “proxy”) data which may be appropriate for different situations. If the last known value for a data element is available, and it changes infrequently that value may be used. The advantage of encapsulated sets of data is that advanced algorithms may be used to generate missing data. If the data set is order dependent, averaging nearest neighbor values may be appropriate or using a data value from a nearby member. For non-ordered sets statistical mean, geometric mean or a regression analysis may generate an acceptable data point. Those skilled in the art will recognize appropriate manners for generating missing data for particular applications.

Individual data elements that represent a feature for each sample in the encapsulated set can be scaled against the members of the set. This removes absolute numeric values and replaces them with statistical distributions against the encapsulated data set. This allows a neural network to find a pattern that can still function when there is a shift in data value ranges.

Leaving individual set member data intact allows for advanced neural net algorithms such as convolutional neural networks to be used on the multi-set encapsulated data type. This approach can also be used with only features and no image, video or sound data. The consistent location of an individual member's data into column and row locations allows advanced neural network algorithms to understand feature location across the data set. For example, Row 1, column A contains information about feature F for the data set member Ml. Subsequent rows at column A contain the information for the same feature F for other members of the set. This allows the neural net to align on that column for feature comparison across the set. Algorithms like convolutional neural networks can be used when setup along these feature columns.

Training a neural net with an encapsulated multi-set data type involves pairing each encapsulated multi-set data element with an optimal output (typically an output for each set member) and updating the values of the parameters of the neural network to minimize a loss function. This is accomplished through an iterative series of computations known as back-propagation and a training technique (e.g. Stochastic Gradient Descent, Adam Optimizer or other known training technique). The backpropagation is accomplished by computing an error for each layer starting with the output layer and adjusting parameters for each layer below to minimize the loss. The neural network is training to accurately determine the correct outputs for any given multi-set encapsulated data. The neural network type can be, but is not limited to, a feed forward neural network, a convolutional neural network, or a modular neural network.

An advantage to the multi-set encapsulation is the generation of additional training cases by shuffling the data for individual set members within the multi-set encapsulation, while not shuffling the environmental or situational data. For a set of N items there are N! (factorial) ways to order the set. For example, a set of 6 articles, actions or events can generate 6! or 720 unique training examples. In situations where training examples are limited this is a benefit for a neural network that will improve outcomes.

The system and method in this embodiment offers many advantages over other known systems and methods. It combines what would have been several different machine learning algorithms running several times across each member of the data set into a single neural network. Not only does this simplify the process by removing tuning between disparate machine learning systems dealing with the data in different algorithms, it also removes tuning across different members of the data set. It also increases accuracy as it allows the neural network to weight image, video or sound attributes directly against features across all members of the data set, in combination with situational data, within a single neural network.

The trained neural network can now be used to perform automated predictive analysis, classification, feature detection, ranking, and initiate subsequent action when presented with an unknown multi-set encapsulated data instance. The unknown multi-set encapsulated data instance is assembled by combining single encapsulated data types representing unique members from a set of articles, actions or events and combining feature data about the situation or environment to create a single multi-set encapsulated data type following the steps outlined for training the neural network. The resulting multi-set encapsulated data type is presented to the neural network for a feed-forward computation of outputs. At each level of the neural network values are computed for each neuron based on weights and biases for each input. The resulting output is then passed to the next level of the network as the input for that level. The final layer of the neural network computes a probability, sometimes called a confidence factor, based on the output values of the layer below it. Outputs represent categorization, feature detection, ranking, subsequent action or some other computable value. An advantage of this feed-forward step over traditional methods and systems is the simplification of many machine learning algorithms, running across the members of the data set, into one neural network. This decreases the required computational power and increases the computational speed allowing for real-time feedback or action on smaller computational devices.

In another embodiment of the multi-set encapsulated data methods, individual members of the set of articles, actions or events need not be accompanied by an image, video or sound data and instead are represented only by qualitative and quantitative information. The other advantages of the multi-set data type remain intact including consistency of feature location across members of the set for advanced neural net algorithms, shuffling to create additional training sets, filling in missing data, and the ability to handle range shifts in individual features.

Also disclosed herein is a method for measuring the accuracy of the system's rankings or outputs when computing such outputs on multi-set encapsulated data with mutually exclusive outcomes. Due to the system's ability to use a single neural network to create forecasts for a differing number of articles, actions or events that may have differing numbers of possible outcomes, it becomes difficult to create a meaningful metric for measuring the performance of the system. When measuring the accuracy of the output it is important to consider the number of possible outcomes being forecast, the overall number of instances of all classes, discernment from previous observed frequency for each individual outcome, and actual instance of category occurrence for each item being forecast. Events can have different numbers of class outcomes and hence greater uncertainty. Methods such as common formulations of the Brier Score are not applicable for comparing forecast skill for one or more events. The average frequencies of incidence for each category within the forecast must be accounted for in addition to error and inherent uncertainty. To compute the forecast skill for each category within a forecast event a modification of the Brier Score is disclosed.

Embodiments using the advantages of the multi-set encapsulated data type with a deep learning neural network are disclosed below in the detailed description and include real time speech understanding and sporting/race result prediction.

In another aspect, an enhancement to the multi-set encapsulated method and system uses a keystone location. A keystone location is a non-changing location of a single set member's data. This allows the neural network or machine learning algorithm to make specific predictions and measurements for the keystone member relative to the entire set. A unique non-changing location is selected within the encapsulated set and maintained as a keystone location for training and prediction by a neural network or machine learning algorithm. Keystone-based multi-set encapsulated data can then be used to train a neural network to perform for a unique member of a set, relative to the other members of a set; an automated predictive analysis, classification, feature detection, ranking, or action.

Training a neural net with a keystone-located encapsulated multi-set data type involves pairing each encapsulated multi-set with an optimal output for the keystone location member and updating the values of the parameters of the neural network to minimize a loss function. Missing data can be filled in, and feature data across the set can be made range independent, just as in the multi-set encapsulated data training and prediction phase. Training the neural network involves the same methods as disclosed in the multi-set encapsulated methods and system.

An advantage to the keystone location multi-set encapsulation is the generation of additional training cases by shuffling the data for individual set members within the multi-set encapsulation for all locations except the keystone location, again without shuffling the environmental or situational data. For a set of N items there are (N−1)! (factorial) ways to order the set. For example, a set of 6 articles, actions or events can generate 5!, or 120 unique training examples. In situations where examples are limited this is a benefit for a neural network that will improve outcomes.

The trained neural network can now be used to perform automated predictive analysis, classification, feature detection, ranking, and initiate subsequent action, for a specific member of the data set, when presented with an unknown keystone location multi-set encapsulated data instance. The unknown keystone multi-set is assembled similarly to the multi-set encapsulated data type with the exception that the single member which is being measured by the neural network or machine learning algorithm is placed in the keystone location. The resulting output of the neural network will represent the outputs for the probability or confidence factor for outputs based on the keystone location relative to the data set.

Traditional methods and systems for predicting a specific outcome of a single member for a constrained set of objects predict an outcome for each member of the set and attempt a combination of those values into a forecast for the individual member. The advantage of this embodiment when compared to the traditional methods and systems is a single neural network with reduced computational complexity as it removes the need to compute, combine and tune disparate algorithms. Additionally, it increases accuracy as all members of the set and all data about the set are capable of being tuned by one deep learning neural network.

Detailed embodiments using the advantages of the multi-set encapsulated data with keystone location methods and system are supplied in the detailed description and include individual prediction for a sports competitor, predicted individual financial investment performance, and autonomous control system improvements.

The foregoing and other embodiments can optionally include one or more of the following features, alone or in combination, as may be suited for a particular application, and to achieve particular desired advantages for each such application. A neural network can be made more accurate at predictive analysis, ranking and classification than existing methods. A neural network can be implemented with reduced complexity, reduced predictive computational requirements, and reduced time for prediction. Additional training sets can be generated from a limited number of training examples. Accuracy of prediction can be evaluated relative to a predictive performance set.

Features and advantages of the invention will become apparent from the figures, detailed descriptions and claims. These and other advantages will be apparent to those of ordinary skill in the art by reviewing the detailed description and accompanying drawings.

### BRIEF DESCRIPTION OF THE DRAWINGS

FIG. 1 illustrates a system and method for training a deep learning neural network that is capable of merging object image, sound or video data with features into a singular encapsulated data type for training a neural network or other machine learning algorithm.

FIG. 2 illustrates a simplified example of methods for assembling digital image or sound sample for an article, action or event with features of said article, action or event into a single encapsulated data type that can be used for training and prediction in deep learning neural networks.

FIG. 3 illustrates a system and method for utilizing a neural network to do predictive analysis, classification, feature detection, ranking or subsequent action for an unknown article, action or event that is represented by a single encapsulated data type comprised of an image, sound or video and features.

FIG. 4 illustrates a system and method for training a deep neural network to perform automated predictive analysis, classification, feature detection, ranking, and subsequent action, within and/or relative to a set of N articles, actions or events, for a given outcome by combining image/video/sound and feature information about each member of the set with qualitative/quantitative situational data in a multi-set encapsulated data type.

FIG. 5 illustrates a simplified example of assembling a multi-set data element for use as an input for a neural network or machine learning training or prediction.

FIG. 6 illustrates creating a permutation of a multi-set encapsulated data example to be used by a neural network, as well as use of a keystone location within the permutation.

FIG. 7 illustrates the multi-set methodology without image, video or sound data for a multi-set set for eight set members with situational information.

FIG. 8 illustrates a system and method utilizing a neural network to compute an output (predictive analysis, classification, feature detection, ranking or subsequent action) for a set of unknown articles, actions or events that is represented by a multi-set encapsulated data type, or to compute an output for a single member of the set when extended with a keystone location.

FIG. 9 illustrates a high-level block diagram of a computing apparatus in accordance with embodiments discussed herein.

FIG. 10 illustrates an embodiment that creates a medical diagnosis probability based on a medical image and feature data of the patient.

FIG. 11 illustrates an embodiment that creates a weather forecast based on a weather image (or series of images—a video) and feature data related to regional or locational weather.

FIG. 12 illustrates an embodiment that uses a radiographic image and parcel data to assess security concerns posed by mail and parcels.

FIG. 13 illustrates an embodiment that creates a real time control system for a computing apparatus that is understanding speech.

FIG. 14 illustrates an embodiment that creates a performance forecast for an event with one or more competitors using multi-set methods without an image, video or sound.

FIG. 15 illustrates an embodiment that creates a performance forecast for an individual player at an upcoming sporting event using multi-set encapsulated data with a keystone location.

FIG. 16 illustrates an embodiment that creates a performance forecast for a set of securities from a multi-set encapsulated data with a keystone location.

FIG. 17 illustrates an embodiment to facilitate motion decisions for an autonomous vehicle with multiple robotic appendages, by combining multi-set encapsulated data with a keystone location for each appendage with situational data to activate an appropriate action for each appendage.

### 4. DETAILED DESCRIPTION

Computing systems and methods as disclosed herein create deep learning neural networks that can perform automated predictive analysis, classification, feature detection, ranking, and subsequent action among a set of one or more possible articles, actions or events with reduced computational complexity and increased accuracy when compared with other known methods. Embodiments are described to facilitate understanding of the methods for assembling the digital information, filling in missing data, creating additional training data, training the system, utilizing the system for prediction and controlling physical devices in real-time with measurable outcomes. Objects and actions are represented digitally, and manipulations are digital manipulations accomplished in the memory or circuitry of a computing system. It is understood that the disclosed embodiments are implemented using data stored within a computer system with computational circuits provided within the computer system.

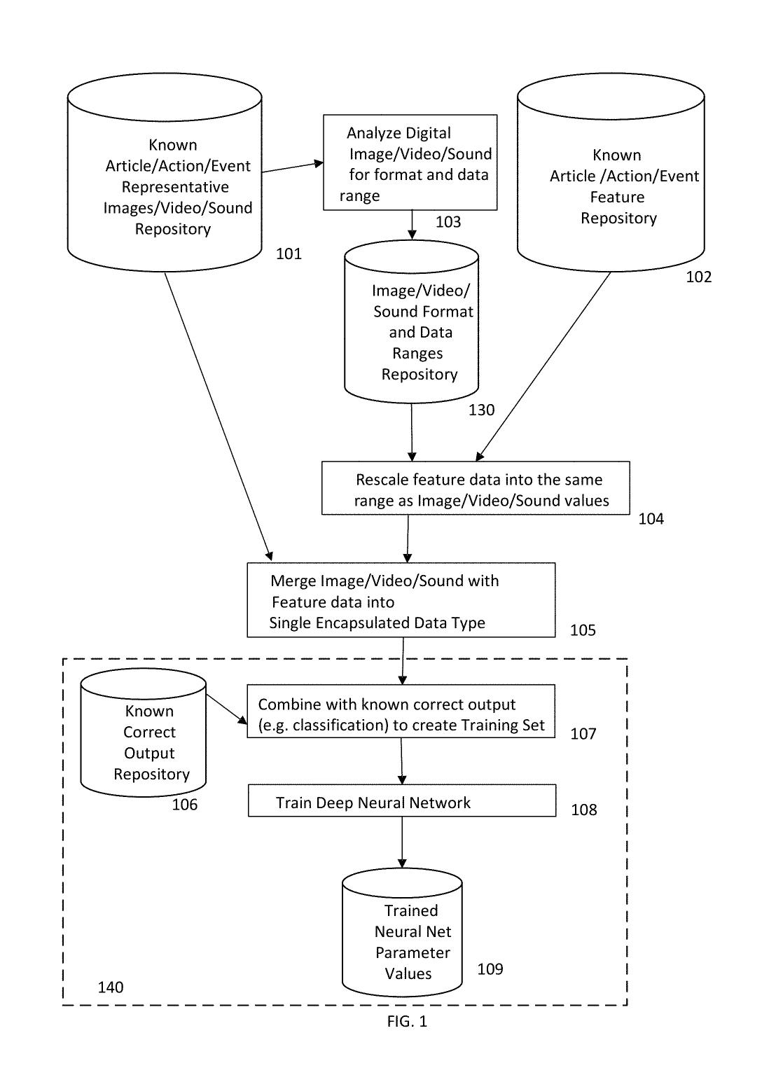

FIG. 1 illustrates aspects of a system and method according to one embodiment for training a deep learning neural network that is capable of merging article, action or event image, sound or video data with feature data into a singular encapsulated data type. Note that FIG. 1 is presented in a manner that simultaneously presents to those of skill in the art both a system architecture and a flow diagram showing the operation of the system architecture.

A representative data repository 101 is a computer memory subsystem provided to collect and store disparate data for processing. Note that if such data did not come from an external source, repository 101 may be implemented as a processor, rather than merely a repository, to generate or otherwise obtain such data and then store it. In the illustrated embodiment, such data is collected and stored in advance of the training phase detailed above. Images/Video and/or sound for known articles, actions or events are converted and stored in a digital representation. Digital representations for images are stored by pixel in a standardized height and width for the training. Each pixel may have multiple channels, one channel for grayscale or multiple for color (Red, Green, Blue). Sound is stored in a digital format based on a sampling rate and bit resolution for each sample. In the case of one or more microphone inputs there may be multiple channels stored for each sound sample. Video is stored as a frequency-sampled series of images with an accompanying sound format. Images/Video and Sound have been normalized to bring the values within an acceptable range for the stored format (i.e. bit depth). Whatever format is used, total sample size is kept consistent for further processing steps and all samples fit within a common size. Those skilled in the art will recognize that various additional processing steps, typically known in the industry as data normalization and scaling, are used to achieve such common size and format.

A feature repository 102 is a second computer memory subsystem that assembles and stores feature information (often referred to as metadata) before the training phase. Note that if such data came from an external source, processor 102 may be implemented as merely a repository. Such information about the known articles, actions or events is collected, encoded digitally and placed in a computer memory storage. Digital storage of textual and numerical information may involve utilizing known algorithms for encoding information into various digital formats such as “one hot” encoding qualitative information (turning one bit on for the appropriate category) and placing quantitative values into normalized distributions. For example, 101 may include the digital representation of an x-ray of a patient's abdomen, while 102 would contain information about the patient such as height, weight, age, race, and a list of known ailments.

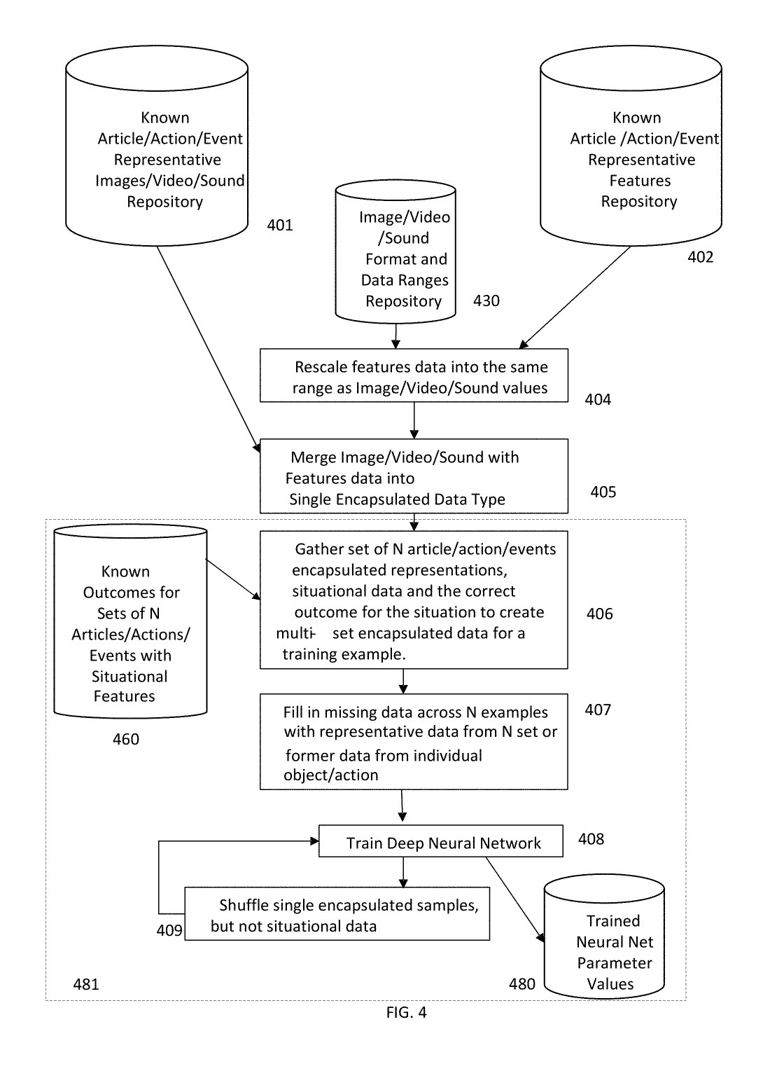

A format/range analyzer 103 takes as input the data stored in representative subsystem 101 to identify both the format and value ranges corresponding to such data and stores this information in ranges repository 130, a computer memory subsystem. This may be apparent from the format the image, video or sound has been stored in, for example an industry standard that, by definition, provides the correct format and ranges. While there are many standards and formats for Images, Video and Sound, they share similar qualities which can be used by the system and methods presented. For each format an expected structure (byte layout) and expected ranges are collected: Image Width (W) and Height (H) of the standard image format, channel depth (C) e.g. (3 for R, G, B) and allowed value ranges (B) bits per channel. Information on sound format includes sample rate per second (fs) also called frequency, channels (Sc) (e.g. 2 for stereo), and audio bit depth (Sb). Video is a combination of a sampling of Images per time period (frequency) and digital format (bit and byte layout, ranges). Retaining the underlying format of the image, sound or video allows consistent processing in later stages. The analysis of the format and acceptable values ranges will be used in other steps for scaling qualitative and quantitative data ranges for neural network training and adjustment of data ranges, for instance in connection with a prediction method corresponding to FIG. 4.

A rescaling processor 104 takes as input the data stored in repositories 102 and 130. Using those as inputs, processor 104 digitally encodes and rescales each feature within the acceptable ranges and formats of the image, video or sound data to be used in training. Qualitative and quantitative data (also referred to as feature data) is gathered for each known article, action, or event to be used in training. For an individual measured feature value of type X the minimum value (Xₘᵢₙ) and maximum value (Xₘₐₓ) are collected. The reference maximum and reference minimum values that must be represented are referred to as Rₘₐₓ and Rₘᵢₙ.

Each possible encoded feature in the sample set must be manipulated to fit within one or more individual sample values of the underlying image pixels, sound samples or video samples format. Feature X can either be scaled or normalized to fit the merged data depending on the distribution of values for the feature. For a uniform distribution, an individual value (Xᵢ) of a sample's feature may be scaled using

$${scaledX}_{i} = ( {R}_{max} - {R}_{min} ) * ( \frac{{X}_{i} - {X}_{min}}{{X}_{max} - {X}_{min}} ) .$$

If a representative set of feature X possible values is a normal distribution, then the Xᵢ value can be normalized with a known algorithm such as z-score or 12 normalization and then scaled into the range of Rₘᵢₙ to Rₘₐₓ. Data outside the normalized values is represented as a maximum or minimum rather than an unbounded value.

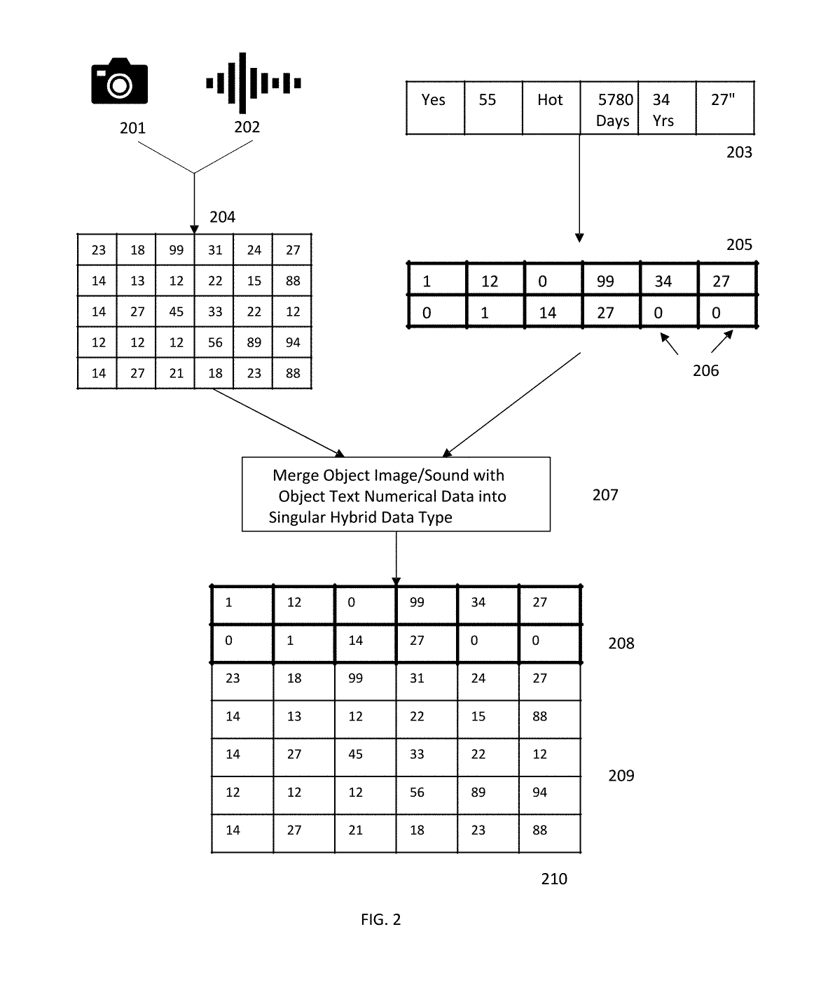

A merge processor 105 takes as input the data stored in representative data repository 101 (data for an individual object/action) and the output of rescaling processor 104 (scaled feature data for the same object/action) and combines them into a new single encapsulated data type. Referring now also to FIG. 2, an exemplary (simplified) diagram clarifies this combination, as detailed below. The combined data requirement is a consistent data set size of predefined byte order (format and channel or frequency), size (height, width, or number of samples), and value ranges, that can be used in training the neural network. Expanding the format in a systematic way allows feature data for the individual article, actions or events, to be embedded with the image, sound or video representing the same article, action or event, without disturbing the integrity of the underlying data. The feature data is added as an extended height, extended width or additional sample, which allows a deep learning neural net to utilize known advanced methods like convolutional neural networks. These advanced neural network algorithms take advantage of information that relates to neighboring information (e.g. nearby pixels in an image) or nearby samples (video frames or sound samples). For an image of W Width and H Height and C channel depth (W*H*C), the width or height is expanded by n Width or m Height to accommodate the additional feature data about the object. The new image is (W+n)*(H+m)*C where n, m are integers and the expansion accommodate all of the binary information to be inserted which represents the encoded and range adjusted feature data about the sample. If there is insufficient data to entirely fill the expansion it is padded with zero, null or mean value to create the necessary bit or byte size. For a sound or video format, the encoded feature information represents one or more prepended or appended additional samples necessary to provide the binary capacity to represent the encoded and range adjusted information. If there is insufficient data to entirely fill the expansion, data is padded with an appropriate null, 0 or mean value. While this makes the image, sound or video file not understandable by a human utilizing decoding software, it can be used by machine algorithms for machine learning and later machine recognition or prediction. The existing image, video, or sound information is preserved and shifted.

A known correct repository 106, a computer memory subsystem, stores, prior to training, the correct analysis, classification, feature detection, ranking or appropriate action for each of the known articles, actions, or events. This repository of expected “outcomes” is the output the neural network will be trained to produce by adjusting parameters of the neural network, sometimes referred to as “ground truth” by those of skill in the art.

A training set creation processor 107 takes as input items from the known correct repository 106 and corresponding output items from merge processor 105 and pairs them to create training example to be used by the deep learning neural network.

A training processor 108 takes the output of data set creation processor 107 and presents the deep learning neural network with the known outputs and single encapsulated data types to learn complex recognition patterns. As recognized by those skilled in the art, a feed forward neural network is a neural network structure with a training algorithm known as back-propagation. Neural networks function by looping through the data over several training passes adjusting the values of neural network parameters to minimize a loss function given a current set of assignments as compared to the optimal assignment. On each iterative step the values of the network are updated in a step known as backpropagation using a technique like stochastic gradient descent. The error for each layer in the neural network is propagated backwards to adjust the parameters in each neural network layer. These parameters are referred to as weights and biases for each neuron at each level of the neural network and are adjusted dependent on the activation function of the neuron, the learning rate, and the learning algorithm. The neural network type can be, but is not limited to, a feed forward neural network, a convolutional neural network, or a modular neural network.

The trained parameters of the neural network are stored in parameter repository 109, a computer memory subsystem. These parameters will be loaded into a neural network (whether on the same computing platform used for training or another computing platform) to run the network in feedforward mode where the neural network computes an output representing a predictive analysis, ranking, classification, feature detections, or subsequent action. Note that in some embodiments, the same computing system is used for both the operational and training modes as discussed herein. In such situations, a subset of the processors and other components (e.g., elements 106-109) may be considered collectively as a training subsystem 140 of an overall neural network processing system.

Referring again to FIG. 2, more detail is now provided regarding an exemplary method for assembling digital image, video or sound sample for an article, action or event with feature data of said article, action or event into a single encapsulated data type that can be used for training and prediction in deep learning neural networks.

An image 201 (which may be, for example, an image from a video of an article, action or event) is taken and converted to digital representation and stored in computer memory 204.

A sound sample 202 (again of an article, action or event, for example) is quantized and converted to digital representation (ADC or analog to digital converter) and stored in computer memory represented 204. Note that, as previously described, the memory structure 204 used for storing both image 201 and sound sample 202 is arranged in a format capable of handling multiple image types, for example here a format organized as width*height*channel depth, or the sound is stored as a digital representation for a series of time samples taken at a given frequency.

Feature data 203 of an article, action or event is collected and stored in computer memory 205. In the example of FIG. 1, such feature data includes six features: these values are meta data about the subject of the image, video or sound. In this illustration 204 represents a region of a patient's abdominal x-ray and 203 represents a portion of a patient's medical exam: Is the patient taking fluids? Yes. Glomerular Filter Rate: 55. Has the patient been complaining of being Hot or Cold or Normal? Hot. How many days since their last physical? 5780 days. How old is the patient? 34 years. Waist Circumference 27″. In this example, memory structure 205 includes textual and numeric data that is encoded and converted into a format in congruence with that of memory structure 204. More generally speaking, in various embodiments data for structure 205 may be adjusted to match the row or height value of data in memory structure 204 or, in the case of sound or video, to fit within a series of samples capable of representing all the bytes required to represent the encoded values. Values are likewise adjusted to be within the same range (min and max) as the data in structure 204.

Note that in numerous applications, it may be that the actual data for structure 205 may not match the size requirements for structure 205. In that instance, additional null (zero) data is inserted to match the sample size of structure 204, as shown by null entries 206. This is necessary to preserve the digital representation of the image/video or sound.

A merge processor 207 is used to combine, as a memory structure 210, the data from structures 205 (now portion 208 of structure 210) and 204 (now portion 209 of structure 210). Structure 210 is then capable of being stored as an encapsulated data item in computer working memory or on computer disk as may be desirable for downstream processing.

Thus, structure 210 illustrates a combined single encapsulated data type containing image, video or sound data with encoded and scaled feature data. This allows machine learning algorithms that take advantage of spacial or time-based information that is positionally represented in the underlying data. This single encapsulated information may now be used by machine learning or neural network algorithms and has the benefit of containing all the data in one data representation allowing a deep learning neural network to build representations in one neural network and subsequently generate outputs more rapidly with reduced computational requirements.

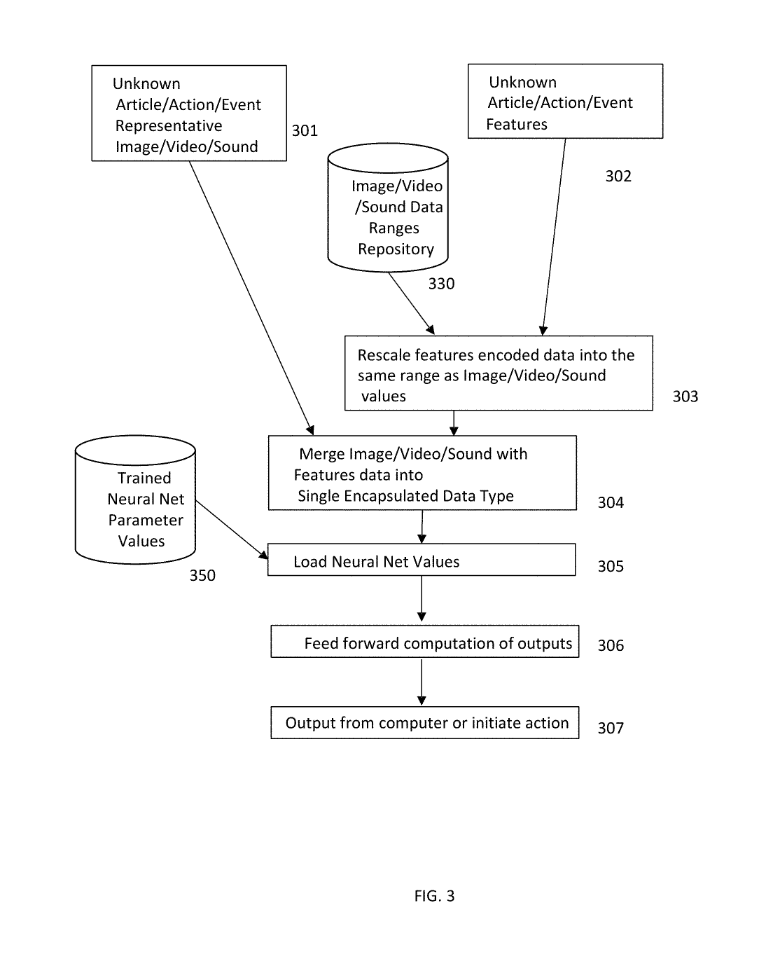

FIG. 3 illustrates aspects of a system and method according to one embodiment of a neural network, the training of which was described in connection with FIG. 1, to perform predictive analysis, classification, feature detection, ranking or subsequent action for an unknown article, action or event that is represented by a single encapsulated data type.

An input processor 301 provides images, video and/or sound that are acquired and placed in a digital representation in computer readable memory for an unknown article, action or event in the same format used for this information in repository 101 of FIG. 1. Note that if such data came from an external source, processor 301 may be implemented as merely a repository.

Following the example of the prior sentence, ranges repository 330 is a computer storage medium that stores, range/format information as set forth in connection with elements 103 and 130 of FIG. 1.

Feature processor 302, in one embodiment, processes feature data of unknown articles, actions or events that are collected, encoded digitally from an external source, similar to the description of repository 102 of FIG. 1. For example, feature processor 302 operates, in one embodiment, to take note of the time at which certain data processed by input processor 301 was created. Additional data assembled by 302 represents feature data about the same object for which data is stored in 301. As with processor 301, processor 302 may in some embodiments be implemented merely as a repository, if the features are merely provided from an external source (i.e., some upstream processor already determined the time at which certain data was created).

Rescaling processor 303 and merge processor 304 operate as previously described with respect to elements 104 and 105 of FIG. 1, respectively.

A neural network preprocessor 305 combines the encapsulated data provided by merge processor 304 with the parameter values stored in trained neural net parameter value repository 350, thereby providing the inputs (both data inputs and weights/biases) for feed forward neural network processor 306.

Neural network processor 306 uses conventional feed forward neural network methods to generate an output representing a predictive analysis, classification, feature detection, ranking or subsequent action, depending on the application the network is designed to address. There are several known output calculations that can be used for the final output layer producing different outcomes depending on the expected distribution of outputs. These include but are not limited to Linear units, Sigmoid units, and SoftMax units. Those skilled in the art will recognize which are most applicable to any particular problem domain.

The output of the neural network processor 306 is represented in some embodiments as a series of values or values to be displayed or printed. In some applications, such a value above a predetermined threshold value or using a maximum among the outputs is used to initiate subsequent action by a downstream processor 307.

FIG. 4. illustrates aspects of a system and method according to one embodiment for training a deep neural network to perform automated predictive analysis, classification, feature detection, ranking, and subsequent action, within and/or relative to a set of N articles, actions or events, for a given outcome by combining image, video, or sound and features of each member of the set with qualitative or quantitative situational data in a multi-set encapsulated data type. These aspects are extensions of those addressed in FIG. 1.

Qualitative/quantitative situational data is defined as information relevant to the comparison of a set of articles, actions or events for the current outcome but disparate from the individual members of the set. This qualitative/quantitative situational data may be referred to as situational feature data. By example, in comparing N possible actions for a flying autonomous vehicle (go up, down, left, right, decrease speed, increase speed) to reach a goal location, situational feature data may include distance from the goal, the immediate vicinity terrain elevations around the vehicle, wind speed, wind direction, and temperature.

Image, sound or video data that has been collected for each article, action or event is stored in known repository 401, a computer memory storage subsystem, the details of which are as described in connection with repository 101 of FIG. 1.

Likewise, features repository 402 corresponds to repository 102 of FIG. 1; format/range repository 430 corresponds to repository 130. Rescaling processor 404 and merge processor 405 correspond to elements 104 and 105 of FIG. 1, respectively.

Prior to training, the correct (or “ground truth”) analysis, classification, feature detection, ranking or appropriate action, for a set of N known articles, actions or events (set members) is collected and stored in repository 460, implemented by a computer memory structure. Additionally, information is collected and stored in computer memory for features of the situation that involves the N set members.

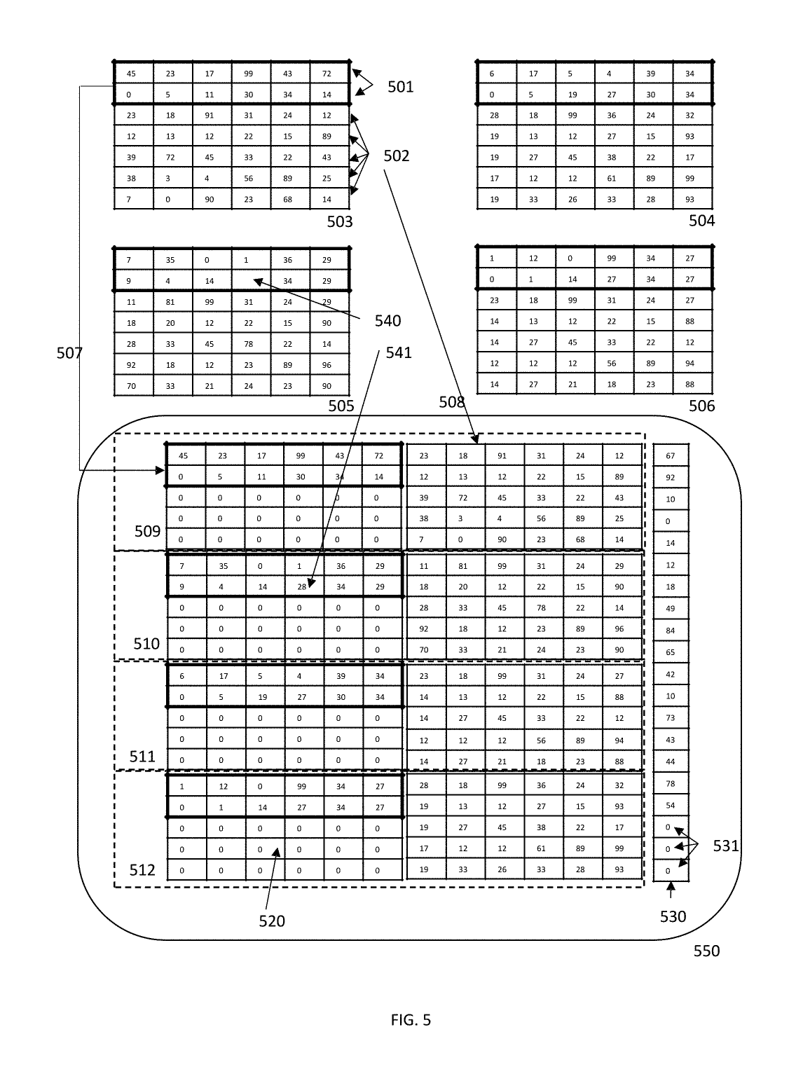

Sets of known outcomes (from repository 460) for a given set, the encapsulated data for each set member (from processor 405), and situational data (from repository 460) are assembled into a multi-set encapsulated data type by processor 406. Referring now also to FIG. 5, there is illustrated a simplified diagram to clarify such assembly, as detailed below. The combined data requirement is a consistent data set size of predefined byte order (format and channel or frequency), size (height, width, or number of samples), and value ranges, that can be used in training the neural network.

Across the set of members, unique features may be adjusted to allow the neural network to handle any future data range changes. This is appropriate for features that are a comparative measurement within the set. For example, relative number of wins or losses for a competitor versus other members in the set, rather than absolute numbers of wins or losses for each competitor. This is accomplished by removing absolute numeric values and replacing them with statistical distributions as compared within the set. These numbers are computed and then range adjusted as by the rescale processor 404.

Merge processor 405 operates as previously described with respect to elements 105 of FIG. 1, respectively.

The training set creation processor 406 gathers a set of encapsulated data elements from processor 405 which are then appended in a manner appropriate for the underlying data format. In the case of assembling a set with image data, the underlying data layout for each member's encapsulated data was (W+n)*(H+m)*C. This step would expand this data to include all N set members, expanding the format to N*(W+n)*(H+m)*C. In the case of assembling set members with sound or video data, the representations of all N members are similarly appended.

Situational data goes through the same process used for individual set member's feature data in processor 404 to adjust the range and values to be appropriate for the underlying image/video or sound format. If the underlying format for the data is video or sound, and the situational feature data is changing with each frame set, the situational feature data must be added to each individual frameset. If the situational feature data is not time dependent then the situational feature data may be added along a new dimension (e.g. a new column or row in an image, or a new video or sound sample). This expands the underlying format to accommodate the bytes required to represent the encoded situational feature data (S).

For an encapsulated data set of size N*(W+n)*(H+m)*C, there will need to be D columns added where (N*(H+m)*c)*D>S. For a sound or video format, the added feature data represents one or more prepended or appended additional samples necessary to provide the byte capacity to represent the encoded and range adjusted information S. If there is insufficient data to entirely fill the expansion, data is padded with an appropriate null, 0 or mean value. While this makes the combined image, sound or video file not understandable by a human using decoding software, it can be used for machine learning and later machine prediction or recognition. The existing images, videos, or sounds information are preserved and shifted or appended.

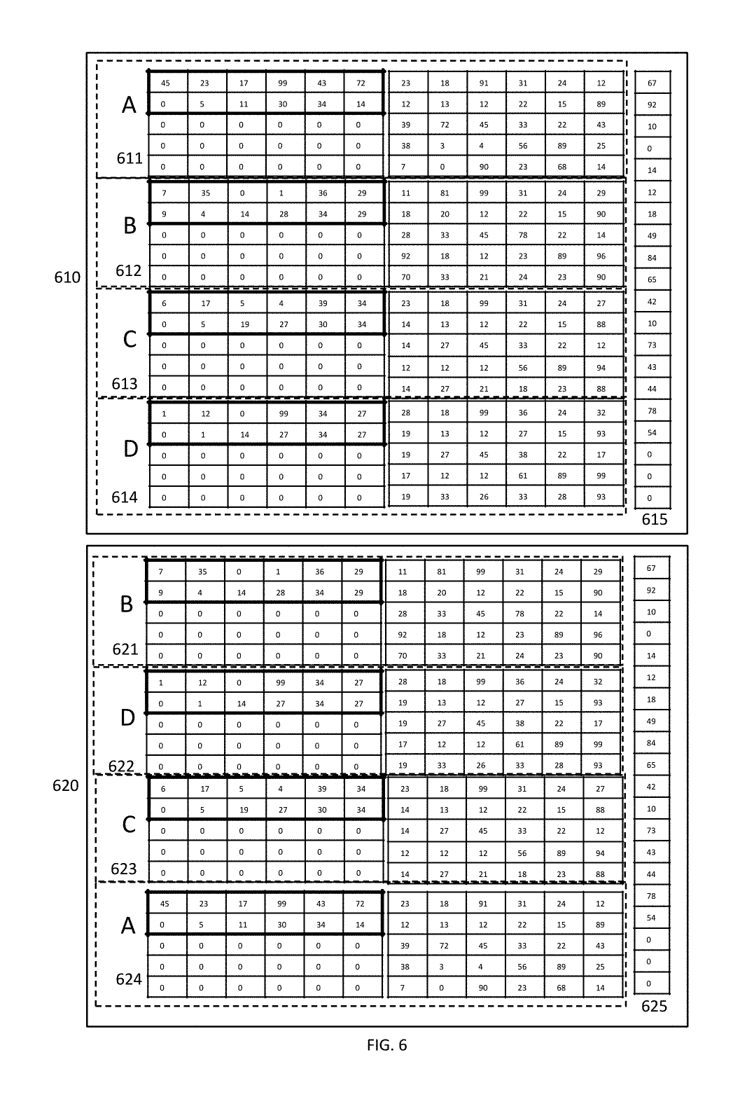

A modification to this approach allows for training a neural network and prediction for a specific set member, relative to the set, rather than an output for the entire set. This involves picking a location, the keystone location, from the set as a fixed location for all training examples present to the network. Outcomes from repository 460 will involve a known outcome for the individual set member located in the keystone location. This is illustrated in FIG. 5 and FIG. 6.

Missing data is filled in for the set member's unique features by the missing-data-replacement processor 407. The algorithm for filling in missing data is dependent on the nature of the feature. If there are older measured values for the specific feature of the individual set member, an appropriate method may be to use the last known value. If the data is order dependent, averaging the values for the same feature of the nearest set neighbors is appropriate. For non-ordered sets, statistical mean, geometric mean or a regression analysis are all algorithms that may generate an acceptable data point. The compiled data that now represents the encapsulated data of all set members with situational features is referred to as a multi-set encapsulated data element.

Training processor 408 trains the deep learning neural network by presenting the known outputs and multi-set encapsulated data from processor 407 to learn complex recognition patterns.

Shuffle processor 409 creates permutations within the multi-set data to provide additional training examples. While the known output will remain the same, the set members are moved to different positions, creating a new training example. This allows the system which has been provided with N set members to generate N! training examples. Situational feature data is not relocated in this process if it has been added by expanding the overall set. It may be shuffled if it was added to individual set member's data. Permutations are further described in connection with FIG. 6.

A modification to this permutations approach allows for shuffling data when a keystone location is in use to train the network for an output about a specific set member. In this modification, all set members are shuffled except for the keystone location, which is the set member for which the known output for the training example has been provided for training. In this case, a system provided with N set members can generate (N−1)! additional permutations for training the neural network.

The trained parameters of the neural network are stored in parameter repository 480, a computer memory subsystem. These parameters will be loaded into a neural network on this computing platform or another platform to run the network in feed-forward mode where the neural network computes outputs, for example a probabilistic fit to possible matching classifications. Note that in some embodiments, the same computing system is used for both the operational and training modes as discussed herein. In such situations, a subset of the processors and other components (e.g., elements 406-410, 460, 480) may be considered collectively as a training subsystem 481 of an overall neural network processing system.

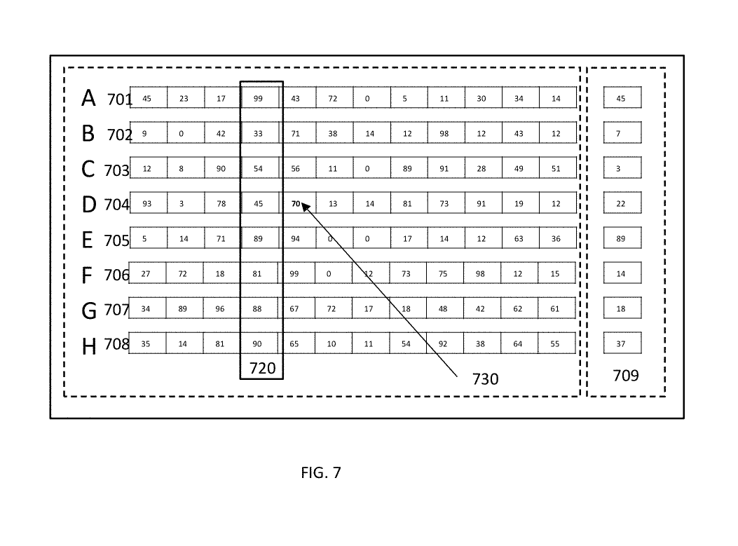

A modification to the approach disclosed in FIG. 4 allows the system to be utilized without image, video or sound data for articles, actions of events (omitting elements 401, 430, 404 and 405). The other steps remain intact as do the benefits of using a multi-set training and prediction methodology with or without a keystone location. An illustration of this type of assembled multi-set is provided in FIG. 7.

FIG. 5 illustrates assembling a multi-set data element input for a neural network or machine learning system to be used for training or prediction. In this case there are 4 separate articles, actions or events. In the case of training a neural network, these would be combined with expected outputs to create a training example. In the case of using a feed forward neural network these would be used as inputs to compute an output(s).

Element 501 illustrates the encoded and range adjusted features of an article, action or event. Assembling and scaling this information for a single set member has been described in FIG. 4, element 404.

Element 502 illustrates the digital image, video or sound information for the same article, action or event as the feature data in element 501.

Elements 503, 504, 505, and 506 each represent features as well as image, video and sound data for different articles, action or events, each to be members of the assembled set.

Element 509 illustrates the merging of feature data from the article, action or event represented by 503 into an encapsulated representation. 507 illustrates the reproduction of feature data in 501 into the correct location in 509. 508 illustrates the reproduction of the image, video or sound data in 502 to the correct location in 509. The feature data has been added to the data in such a way that is does not disturb the integrity of the underlying image, video or sound.

510 represents the encapsulated data for the article, action or event in element 505. Element 511 represents the encapsulated data for the article, action or event in element 504. Element 512 represents the encapsulated data for the article, action or event in element 506.

Element 520 illustrates how feature data has been expanded (padded) to fit within the underlying image, sound or video information. In this illustration, zeros were added to create an example of the same size as the image, video or sound. This has been described in FIG. 4, element 405. Such processing has been applied to the feature data in elements 509, 510, 511 and 512.

Element 530 illustrates the situational feature data relevant to the outcomes for this set of articles, actions or events. Element 531 illustrates how this has been expanded with the value 0 (padded) to be able to extend the combined data set while leaving the encapsulated data for each individual set member intact.

Element 540 illustrates an unknown value for a feature of the article represented in 505. 541 illustrates how that value can be filled in utilizing information from other members of the assembled set. In this case, the value has been filled in with an average of the same feature from the other members of the set (503, 504 and 506). This was described in FIG. 4 element 407.

Element 550 represents the assembled multi set encapsulated data for use by a neural network or machine learning algorithm. The multi-set encapsulated data contains the feature data of all four set members, the image, video or sound for all four set members, and the relevant situational feature data for the assembled set or articles, actions or events.

One of the locations 509, 510, 511 or 512 can be identified as a keystone location. In this method, across all training and feed-forward methods utilizing a neural network the identified location is always used in training the neural network. The location is filled with the set member for which the known output is provided in training. In feed-forward mode, the set member for which a desired output should be computed is located in the same location.

FIG. 6. illustrates creating a permutation of a multi-set encapsulated data element to be used by a neural network. Additionally, this illustrates a keystone location within the permutation.

610 illustrates an encapsulated multi-set element to be utilized by a neural network. 611, 612, 613 and 614 all represent the features and image, video or sound, of unique articles, actions or events (in this case A, B, C and D). 615 represents the situational feature data for the set.

620 illustrates a permutation that can be used with the same known outputs for training. A permutation is an ordering where at least one set member has been moved to a new location. A move involves exchanging the entirety of the image, video, sound and feature information between two set members. Note how the situational feature data, represented by 625 is in the same location and format as it was in 615. It has not been modified.

The method which involves utilizing a fixed keystone location for training the neural network is also illustrated in FIG. 6. The set member illustrated by 613 has not been relocated to a new position in the permutation. 613 and 623 both represent the same set member located in the keystone location. The data for the item, action, or event in 613, and 623 is unchanged between permutations (it is still the data for C).

FIG. 7. Illustrates the multi-set methodology without image, video or sound data. The illustration is for a multi-set set containing eight set members with situational information.

701, 702, 703, 704, 705, 706, 707, and 708 represent the digitally encoded feature data of unique articles, actions or events (in this case, A, B, C, D, E, F, G and H). 709 represents the feature data that is relevant to this set of members.

720 illustrates how this methodology allows for a measurement about a specific feature, for each set member, to be located in the same location. This allows for advanced neural network algorithms to work along columns. An example of this is a convolutional neural network with a convolutional size that is the 1 by N set members in size.

730 illustrates how data can be filled in for a set member that is unknown when used with a multi-set encapsulated element. In this illustration, the feature value for item, action or event D in row 704 was not known. The feature value of the other set members is in the same column location which allows for a value to be computed, in this case 70, by averaging (some other method could have been used) the value of the same feature which is known for other set members.

Any location for set member data, 701, 702, 703, 704, 705, 706, 707, or 708 could become a fixed location to use for the keystone methodology where an output can then be trained or computed for single set member.

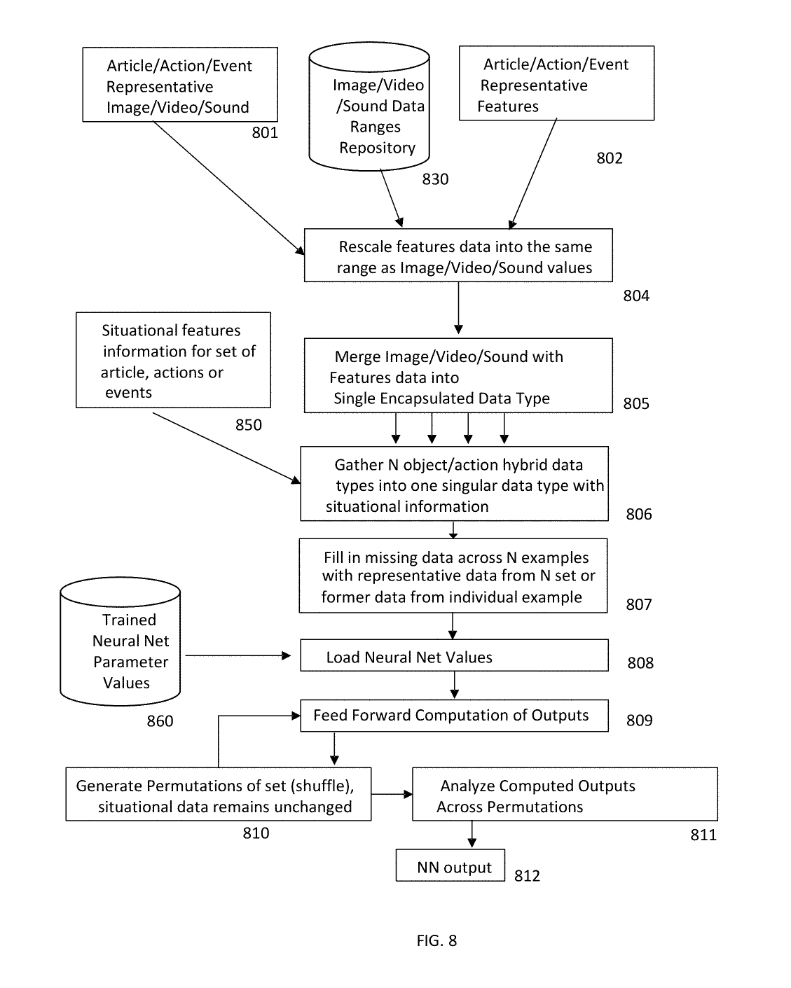

FIG. 8 Illustrates aspects of a system and method according to one embodiment utilizing a neural network, the training of which was represented in FIG. 4, to compute an output (predictive analysis, classification, feature detection, ranking or subsequent action) for a set of unknown articles, actions or events that is represented by a multi-set encapsulated data type. The approach can also be used to compute an output for a single member of the set when used with a keystone location.

Elements 801 and 802 represent collecting image, sound or video (801) and feature data (802) for an individual article, action or event, and correspond to previously described elements 101/102 of FIG. 1 (if merely a repository for externally provided data) and 401/402 of FIG. 4 (if processing needed to generate such data, as previously discussed).

Ranges repository 830 and rescaling processor 804 correspond to elements 430 and 404 of FIG. 4. Features encoded digitally, from the known article, action or event are rescaled to fit within the acceptable ranges and formats of the image, video or sound data to be used in training FIG. 1, further detailed in connection with element 104.

Likewise, processor 805 corresponds to processor 405 of FIGS. 4 and 105 of FIG. 1. Data for an individual object/action is collected from the image/sound repository and combined with data for the same individual object/action into a single encapsulated data type.

Processor 806 combines situation features collected/encoded by processor 850 (corresponding to the described operation of processor 406 and the illustration of FIG. 5). Information is to be computed by the neural network about a set, or for a member of a set (keystone location), of N articles, actions or events, in a given situation.

To the extent there is missing data, processor 807 fills in such data for unique features in the set members qualitative and quantitative data, corresponding to the operation of processor 407 in FIG. 4. Neural net preprocessor 808 then loads values for the operational mode of the network as determined by training, which values are stored in repository 860.

Neural network processor 809 then computes, using conventional feed forward neural network methodology, the predictive analysis, classification, feature detection, ranking or subsequent action. As previously noted, there are several known output calculations that can be used for the final output layer depending on the expected distribution of outputs. These include but are not limited to Linear units, Sigmoid units, and SoftMax units. This calculation may be done multiple times in conjunction with set permutation processor 810 where appropriate permutations of the set are created, and a statistical value based on the different computed values and number of passes is created.

Specifically, permutations of the set can be generated to run through processor 809 again. This increases the accuracy of the computed outputs by allowing the system to compute a statistical value over many passes and arrangements of the set. A simplified overview of this process was presented in FIG. 6. Situational feature data is not moved (shuffled). When the modified method for the system utilizing a keystone data element is in use the data for the keystone member of the set remains in its location while other members are shuffled.

Forecast skill of predictions for computed values as compared to actual values for each individual member of the set can be assessed by analysis processor 811 using a modification of the Brier score. Due to the disclosed systems and methods allowing a single trained neural net to analyze events that may have differing numbers of participants and outcomes, standard methods for assessing forecast skill are not applicable. The following formula can be used to compute forecast skill. Where N=number of set members, R=number of possible computed categories, p=individual categorical probability computed by the neural network, ō=overall average of belonging to a category for an individual member the set (for some events, or when value is unknown 1/N). The score can be used to make comparisons of skill between 2 or more categories belonging to the same event.

$$\frac{{\sum }_{t = 1}^{n} [ {( {p}_{t} - {o}_{t} )}^{2} - {( {p}_{t} - {\overline{o}}_{t} )}^{2} ]}{\overline{o} ( 1 - \overline{o} )} * \frac{1}{n}$$

The mean skill score for all categories belonging to the same event can be used to make accuracy comparisons between events of the same type. This can be achieved using the following formula.

$${\sum }_{i = 1}^{R} ( \frac{{\sum }_{t = 1}^{n} [ {( {p}_{t} - {o}_{t} )}^{2} - {( {p}_{t} - {\overline{o}}_{t} )}^{2} ]}{\overline{o} ( 1 - \overline{o} )} * \frac{1}{n} ) * \frac{1}{R}$$

Neural Net Output processor 808 formats the output from the analysis processor as may be appropriate for downstream processing for any particular application.

A modification to the approach disclosed in FIG. 8. allows the system to be used without image, sound of video data for articles, actions of events. In this method, steps 801, 830, 804 and 805 are omitted. This requires the same modification discussed in FIG. 4 to have been used when computing parameter values for the trained neural network. All other operational details remain intact as do the benefits of using a multi-set training and prediction methodology with or without a keystone location. An illustration of this type of assembled multi-set is provided in FIG. 7.

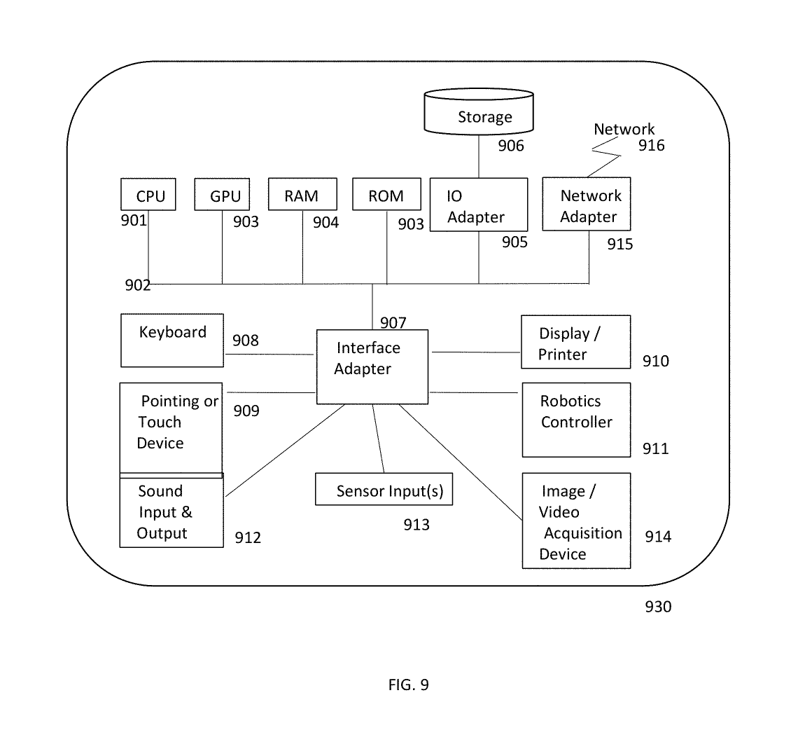

Referring now to FIG. 9, the above mentioned systems and methods for creating deep learning neural networks that can perform automated predictive analysis, classification, feature detection, ranking, and subsequent action among a set of one or more possible articles, actions or events with reduced computational complexity and increased accuracy when compared with other known methods may be implemented on a computing apparatus using well known computer processors, software, memory units, storage devices, and other components. Embodiments of the apparatus and the functional methods described in this disclosure can be implemented in tangible digital circuitry, controlled and enabled by tangible computer software or firmware, in computer hardware, including the structures disclosed or equivalents or combinations of one or more of these structures. Embodiments of the subject matter disclosed can be implemented in part as one or more computer programs (a series of computer instructions). The computer programs may be encoded on a tangible or a non-transitory program carrier to control the operation of, or to be executed by a computing apparatus. In addition, or in replacement, program instructions of the methods can be encoded on an artificially generated signal that is electrical, optical, electromagnetic, or quantum for transmission to a suitable receiver apparatus for execution on or by a computing apparatus. The computer programs may be encoded on a machine-readable storage device. The storage device may use but is not limited to known methods of storing digital data on a combination of one or more storage substrate in random or serial access memory.

The term “computing apparatus” encompasses various kinds of devices and machines for encoding data in a machine-readable format and performing a series of instructions or steps to manipulate the data. This includes computer processors, programmable processors, computers, and/or multiple processors. It also includes virtual processors which are a series of programs performing instructions on a computer apparatus than can then appear to be a different type, or multiple types of computing apparatus. Computing apparatus includes physical hardware, code that creates an execution environment, firmware, communication protocols, operating systems and database management systems and combinations of the aforementioned.

FIG. 9. illustrates a high-level block diagram of a computing apparatus capable of implementing the various processors, repositories and other aspects of the systems described herein, as well as facilitating the methods described herein.

The computing apparatus 930 is composed of several components. While the block diagram shows one representative component it is understood that there may be one or more internal components for additional processing capacity, faster or parallel execution or additional storage. 901 is a central processing unit or processor which controls the overall execution of the computing apparatus 930 by executing computer program instructions which define such operation. The computer program instructions may be stored in a storage device 906 (e.g. solid-state drive) or on the pre-recorded read only memory 903 or remotely stored and read via the network 915. Parallelized execution of numerical operations may happen on an optional device 903, the graphics processing unit, which may speed execution of many of the methods disclosed here. Additional memory is available to the CPU 901 to store intermediate information in the RAM 904. Input and output may be regulated by an optional specialized processor 905. Connecting the system with other computers, a series of other computers (the internet) or devices is handled by a network adapter 915.

An interface adapter 907 provides a communications path for information to flow in and out of the computing platform and is controlled by the CPU 901. Human interface components that allow interaction are represented by a keyboard 908, pointing or touch device 909 and a display (monitor) or printer 910. The computing apparatus may be able to directly interface with the external environment by digitally capturing sound and converting digital input into sound 912 by attaching appropriate devices (e.g. a microphone and speakers). Sensor input 913 may be acquired digitally (for example pressure, weight, or temperature) by attaching appropriate devices. Image and video data may be acquired via 914 by connecting an appropriate capture device (e.g. a digital camera). A robotics controller 911 may be attached to control additional physical devices (e.g. motors and actuators). Implementations of the above interface devices may also be attached through a network 916 via network adapter 915.

The methods and steps represented in this disclosure may be defined by computer program instructions, stored in computer storage 906, RAM 904 or ROM 903 or acquired remotely via the network adapter 915 and executed by the processor 901 with some instructions optionally optimized for parallel execution in the GPU 903. Images, sound, video and feature data may be provided to the computing apparatus through the devices hooked to the interface adapter 907 or through the network 916 and stored in computer memory in storage 906 or RAM 904.

One skilled in the art would recognize that a computing apparatus could contain other components and that FIG. 9. is for illustrative purposes. This entire apparatus could be divided into components and connected via a network. It is also possible to have some components exist only as computer programs running on other computing apparatus (virtualization).

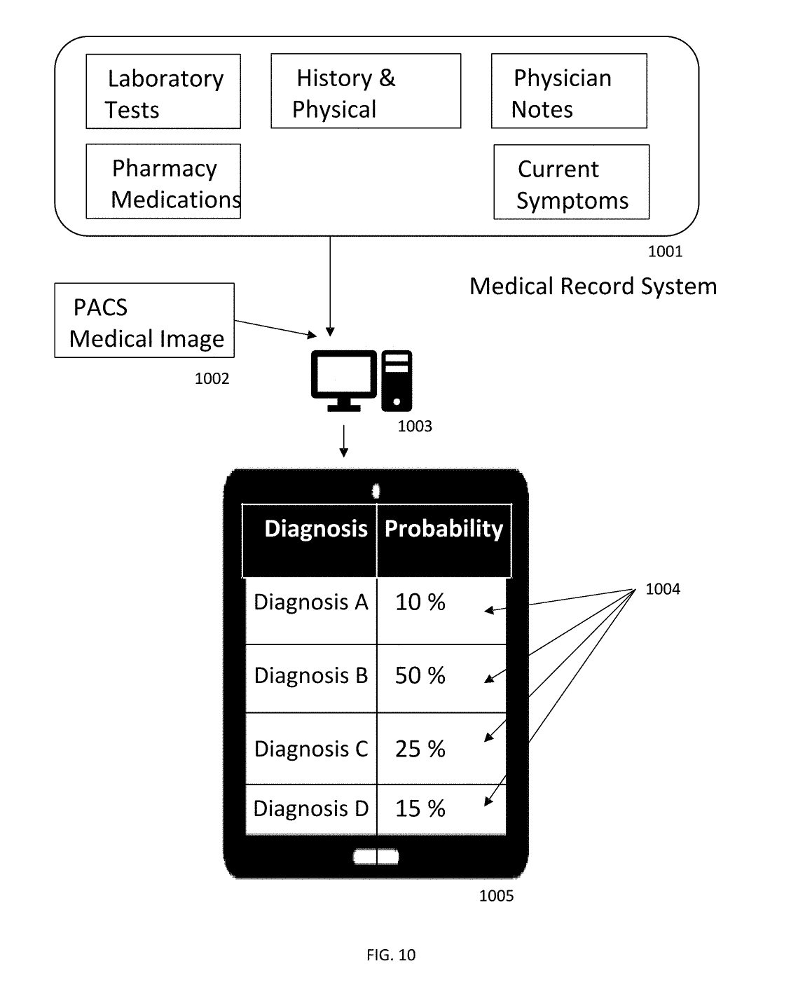

FIG. 10. Illustrates an embodiment of the described systems and methods that creates a medical diagnosis probability based on a medical image and feature data about the patient.

Medical record system 1001 collects various types of medically-related information. This information is digitally encoded on computer storage as previously described. This feature data may include laboratory tests, patient history, physical information, physician notes, medication lists, and current symptoms. Located in this database will also be known diagnoses for the patient.

The medical image in 1002 has been retrieved from a Picture Archiving and Communication System (PACS), a system which stores this information digitally on a computer storage medium. This may be an X-ray, CT scan, MRI, Ultrasound or some other medical image modality. It is related to the data that was in the medical record system at the time the image was acquired. It is understood that this information has been collected by CCD, CMOS or some other digital image sensor and stored in a standard image format appropriate for the image type and at a resolution and depth appropriate for medical imaging.

In a training phase, following the details corresponding to FIG. 1, training examples are created by combining known diagnoses retrieved from the medical records system (known outcomes), the image that was used to reach each diagnosis from the PACs system, and the then current data from the medical records system (feature data). This is accomplished by the computing apparatus 1003 following computer program instructions that have been created to carry out the methods described in this disclosure. The feature data is collected from the medical records system, that was current at the time of the image, and paired with a medical image used by a clinician in that diagnosis. Following operational details set forth in connection with FIG. 1, the image is analyzed, the feature data is scaled, and the data is merged into a single encapsulated data element. The single encapsulated data element is paired with the known outcome (or diagnosis) and presented to the neural network as a training example where the network algorithms will adjust the parameters using back propagation. In this illustration a recurrent convolutional neural network is assumed, but other designs for the neural network would also be applicable. Many such training examples are extracted from the PACS repository and medical record system to reach an optimum accuracy of diagnosis.

In a subsequent operation, a new medical image 1002 is acquired for which a diagnosis is not known. Following the details set forth in connection with FIG. 3, the feature data is retrieved from the medical record system 1001. The computing apparatus 1003 scales the current feature data 1001 (medical record data) and merges this with the medical image 1002. The neural network is loaded with trained parameter values and processes this new encapsulated data element as inputs in a feed forward method to produce an outcome.

The probability of each diagnosis is computed 1004 and displayed on a device 1005 for a clinician.

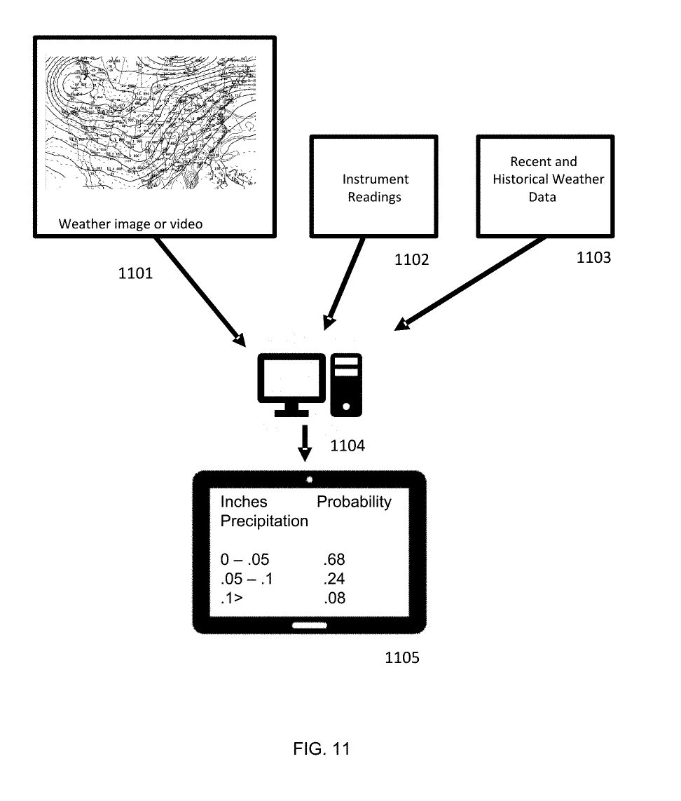

FIG. 11 illustrates an embodiment for a different application: creating a weather forecast based on a weather image (or series of images—a video), and feature data.

A weather image 1101, whether a graphical (pictorial) or video format, has information about the weather in a region or area of the world. This information may include one or more graphical indicators that illustrate differences between areas. Information conveyed from the image may include, but is not limited to, temperature, wind speed/direction, humidity, pressure, solar radiation, visibility, cloud ceiling, and precipitation. This information is digitally encoded on computer storage.

Instrument readings are illustrated in 1102. This feature information includes measurements from one or more weather stations. Information conveyed may include, but is not limited to, temperature, wind speed and direction, humidity, pressure, solar radiation, visibility, cloud ceiling, and precipitation.

Relevant recent and remote historical weather information is illustrated by element 1103. This feature data may include, but is not limited to, general climate trends for the location (e.g. typical rainy season dates, average daily temperatures) and global climate trends (e.g. current El Nino oscillation or volcanic ash cloud information).

In a training phase, following the description from FIG. 1, training examples are created by combining known weather outcomes with an appropriate weather image, or video and relevant feature data information known at that time to create a training example. This is accomplished by the computing apparatus 1104 following computer program instructions that have been created to carry out the methods described in this disclosure. Following the description from FIG. 1, the image is analyzed, the feature data is scaled, and the data is merged into a single encapsulated data type. The single encapsulated data type is paired with the known outcome and presented to the neural network as a training example where the network algorithms will adjust the parameters using back propagation. In this illustration a long short-term memory recurrent neural network is assumed, but other designs to the network would also be applicable. Many such training examples are extracted from historical weather events to reach an optimum accuracy of weather prediction (outcomes).

In a subsequent operation, a new weather image or video 1101 is acquired and a weather outcome is predicted. Following the description from FIG. 3, the feature data is retrieved from 1102 and 1103. The computing apparatus 1104 scales the current feature data 1102, 1103 and merges this with the weather image 1101. The neural network is loaded with trained parameter values and processes this new encapsulated data element as inputs in a feed forward method to produce an outcome.

The probability of a weather outcome (precipitation in this simplified example) is displayed on a device 1105 for a human user.

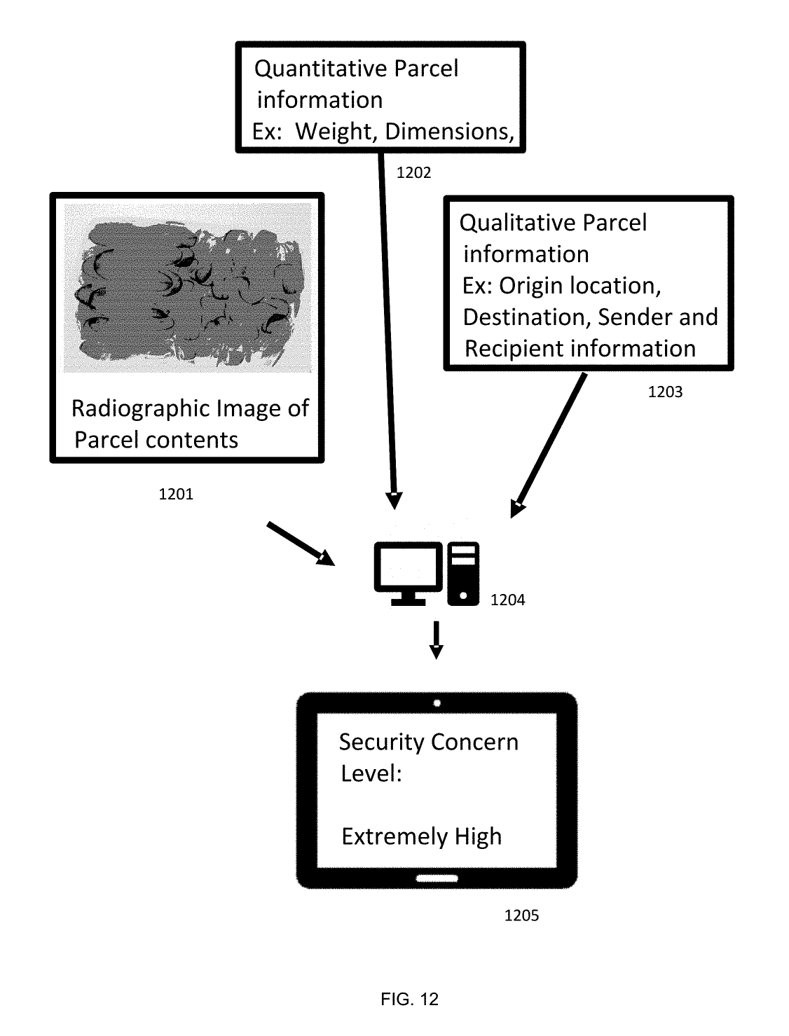

FIG. 12 illustrates an embodiment that uses a radiographic image and parcel data to assess security concerns posed by mail and parcels.

Image 1201 is collected for a particular parcel or piece of mail using radiographic imaging techniques. This information may be color coded to indicate the differences in the elemental composition of imaged contents. This information is digitally encoded on computer storage.

Parcel feature data 1202 is quantitative information related to the parcel, e.g., measurements of weight and package dimensions.

Parcel feature data 1203 is qualitative information related to the parcel, e.g., parcel origin, parcel destination, relevant information about parcel origin and destination, and available information about sender and recipient.

In a training phase, following the description for FIG. 1, training examples are created by combining radiographic images of parcels with appropriate parcel feature data known at that time to create a training example. This is accomplished by the computing apparatus 1204 following computer program instructions that have been created to carry out the methods described in this disclosure. Following the description for FIG. 1, the image is analyzed, the feature data is scaled, and the data is merged into a single encapsulated data type. The single encapsulated data type is paired with the known outcome (security risk) and presented to the neural network as a training example where the network algorithms will adjust the parameters using back propagation. In this illustration a convolutional neural network is assumed but other neural network designs would also be applicable. Many such training examples are extracted from historical examples of security risks and non-risks to reach optimum accuracy in evaluating the security risk posed by individual mail items and parcels.

In a subsequent operation, a new radiographic image 1201 is acquired and a security risk outcome is predicted. Following the description for FIG. 3, the feature data is retrieved from 1202 and 1203. The computing apparatus 1204 scales the current feature data and merges this with the radiographic image 1201. The neural network is loaded with trained parameter values and processes this new encapsulated data element as inputs in a feed forward method to produce an outcome.

The probability of a security risk can be displayed on a device 1205 for a human user and used to screen high risk parcels and mail items for further investigation.

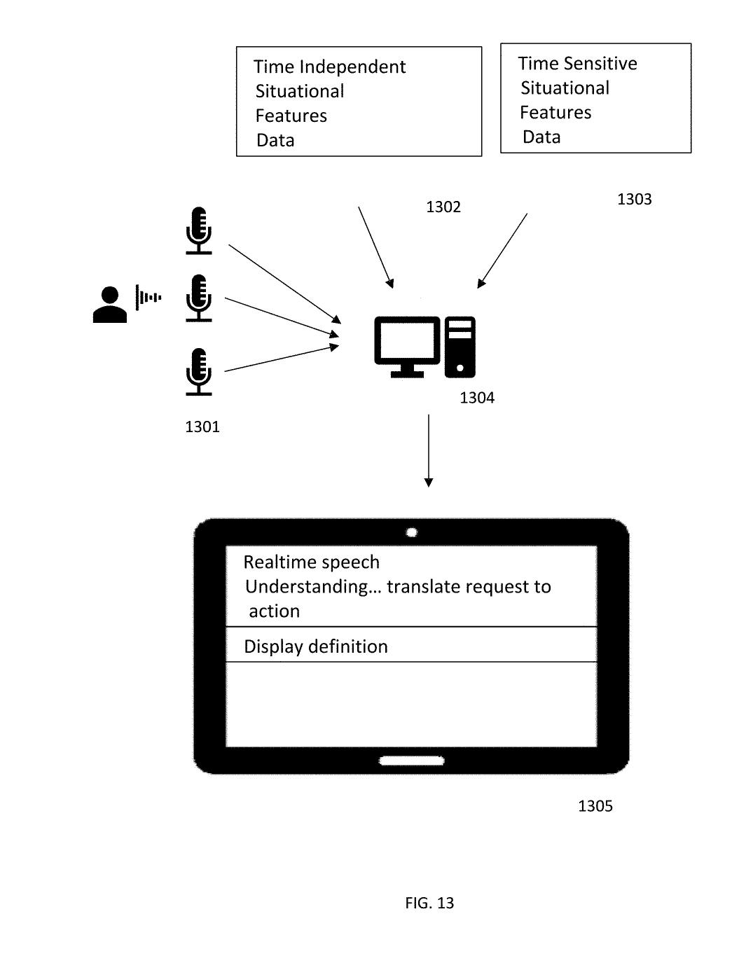

FIG. 13. Illustrates an embodiment that creates a real time control system for a computing apparatus that is understanding speech.

The digitized sound 1301 of a speaker's voice is collected by one or more microphones. Each microphone's sound has been digitized either by the apparatus in 1304 or some other computing apparatus and stored in a computer storage medium in 1304 as a series of sound samples. It is understood that this has been collected using some analog to digital known methodology and encoded in an appropriate frequency bands at an appropriate frequency sample rate and stored in some recognized series of digital sound samples.

Element 1302 represents features that are time independent. This is information that is relevant to the sound being captured which is not changing frequently. This information will be valid across a series of samples that will be analyzed. This may best be illustrated by a simplified example; the speaker is stationary and located in the kitchen.

Element 1303 represents situational feature data that is time sensitive. This is information that is relevant to the sound being captured which is changing frequently and may only be relevant for a short section of analysis. This may best be illustrated by a simplified example: The speaker is looking at step 5 of a recipe on a computer display.

In a training phase, following the description from FIG. 4, training examples are created by combining known speech translations stored in computer storage medium on the apparatus in 1304 with the captured sound 1301 and time independent features 1302 and time sensitive features 1303. This is accomplished by the computing apparatus 1304 following computer program instructions that have been created to carry out the methods described in this disclosure. The feature data is retrieved that was current at the time of the sound sample capture. Following the description from FIG. 3, the sound data is analyzed, and the feature data is scaled. Time sensitive feature data is merged with the appropriate sound sample from the same time frame. Time independent features are merged across the entire encapsulated data set. This multi-set sound sample with data is now paired with a known outcome (correct translation and action) and used as a training example. The neural network algorithms adjust the parameters using back propagation to get closer to an optimal outcome for this multi-set training example. Many such training examples are required to reach optimal outcome. Additional permutations of each training example may be created as described in connection with FIG. 4 and illustrated in FIG. 6.

In a subsequent operation, a new series of sounds 1301 is acquired by one or more microphones for which an outcome is not known. Following the description from FIG. 8, the feature data is retrieved in step 1302 and 1303. The computing apparatus 1304 scales the current feature data 1302 and 1303 and merges this with the sound 1301. The neural network is loaded with trained parameter values and a feed forward algorithm is used to produce one or more outcomes, in this example a connectionist temporal classification neural network is assumed but other neural network designs would also be applicable. Some outcomes may reach a threshold indicating that an action should take place by the computing apparatus 1304. Additional permutations of the multi-set may be created, and values may be computed by the neural net and averaged or some other statistical combination may be used for additional accuracy.

In this illustration, the computing apparatus has understood a spoken command to display a clarification for something that was appropriate for this time independent situation (speaker is in the kitchen) and appropriate for time sensitive situation (speaker is looking at step 5 of a recipe), this data merged with the sound sample to allow the neural net to conclude that what was being asked was clarification of a recipe step to be displayed on output device 1305

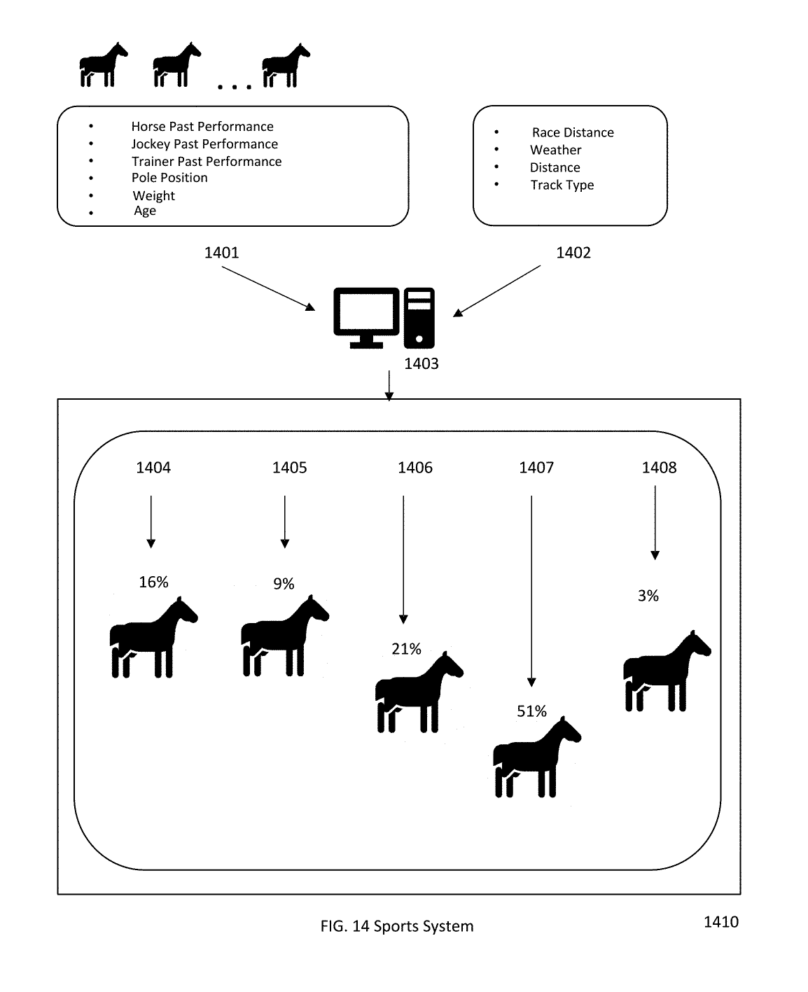

FIG. 14 illustrates an embodiment that creates a performance prediction for an event with one or more competitors using multi-set methods without an image, video or sound.

Past performance feature data 1401 for each competitor has been collected and stored in a computing storage format. 1402 illustrates situational information about the competition that has been collected and stored in a computing storage format. For illustration purposes a horse race has been used but the systems and methods support any type of competitive event analysis.

As detailed above in connection with FIG. 4 and FIG. 7, a neural network is trained using the computing apparatus 1403. The feature data for each competitor 1401 is assembled as outlined in connection with FIG. 7. This stacking of like features allows a complex neural network algorithm to algorithmically determine the relationship between features of each competitor in a given situation.

In a training phase, following the description from FIG. 4, training examples are created by combining the individual feature data for each competitor 1401 with situational features 1402 by the computing apparatus 1403 following computer program instructions that have been created to carry out the methods described in this disclosure. This includes filling in any missing data by following as discussed in connection with FIG. 4. The combination of this data with a known outcome (competitor performance) defines a multi-set training example. The multi-set sample with data is now paired with a known outcome and used as a training example. In this illustration a multilayer neural network configured as a softmax classifier is assumed but other neural network designs would also be applicable. The neural network algorithms adjust the parameters using back propagation to get closer to the optimal outcome for this multi-set training example. Many such training examples are required to reach optimal outcome. Additional permutations of each training example are created as discussed in connection with FIG. 4 and illustrated in FIG. 6.

In a subsequent operation, a new set of features is acquired for a series of competitors 1401 for which an outcome is not known. Information about the competition, 1402, situational feature data, is also acquired. Following the operational details discussed in FIGS. 7 and 8 a multi-set representation of the event is created. The computing apparatus 1403 scales the current feature data 1402 and merges this with the individual competitor information 1401. The neural network is loaded with trained parameter values and a feed forward algorithm is used to produce one or more outcomes, represented by 1404, 1405, 1406, 1407, and 1408. Additional permutations of the multi-set may be created, and values may be computed by the neural net and averaged, or some other statistical combination may be used for additional accuracy. In this illustration, the computing apparatus has produced a set of statistical predictions by competitor to be displayed or printed on device 1410.

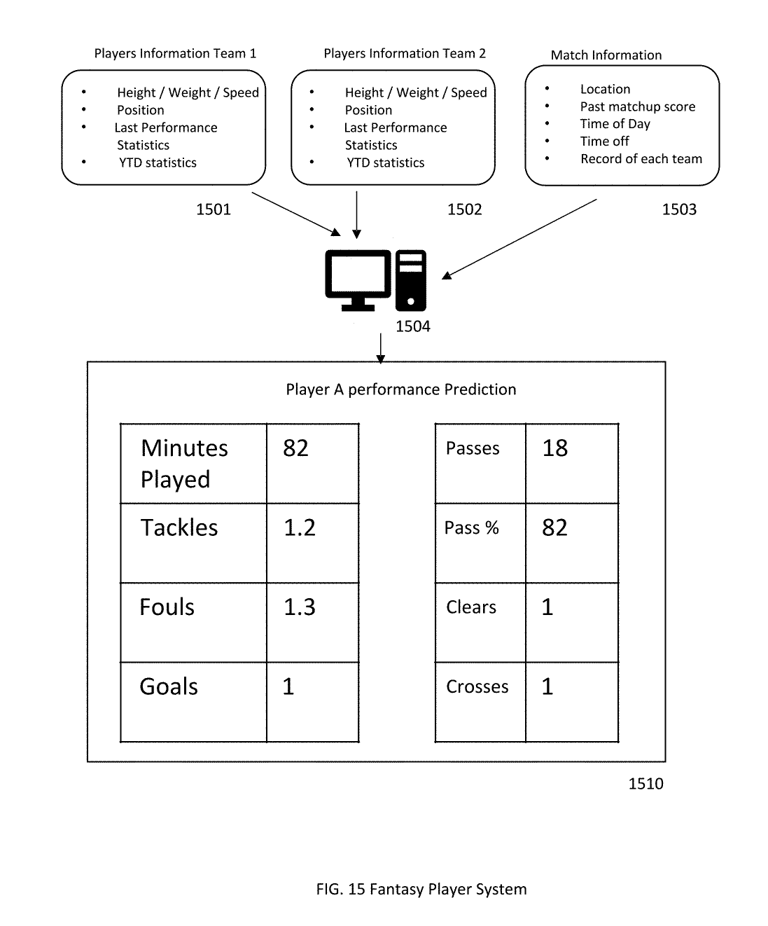

FIG. 15 illustrates an embodiment that creates a performance forecast for an individual player at an upcoming sporting event using multi-set encapsulated data with a keystone location.

Past performance information about each member of each team has been collected and stored in a computing storage format 1501 and 1502. 1503 illustrates situational information about the competition between the teams that has been collected and stored in a computing storage format. For illustration purposes a soccer match has been used in this example but the systems and methods support any type of competitive event analysis.

As described in connection with FIG. 4, a neural network is trained using the computing apparatus 1504. The feature data for each competitor 1501 and 1502 is assembled as outlined in FIG. 7. This stacking of like features allows a complex neural network algorithm to algorithmically determine the relationship between features of each competitor in a given situation. Following the illustration in FIG. 6, a keystone location is located within the multi-set encapsulated data. This represents the location of the individual team member for which the known outcome is used in training.

In a training phase, as described in connection with FIG. 4, training examples are created by combining the individual feature data for each competitor 1501 and 1502 with situational feature data 1503 by the computing apparatus 1504 following computer program instructions that have been created to carry out the methods described in this disclosure. The computing apparatus 1504 scales the current feature data 1503 and merges this with the individual competitor information 1501 and 1502. The combination of this data with one or more known outcomes (player performance metrics) for the individual competitor in the keystone location defines a multi-set training example. Missing data for any feature for a member (competitor) in the set can be filled in following the details presented regarding FIG. 4. The multi-set sample with data is now paired with the known outcome(s) for the keystone location and used as a training example. The neural network algorithms adjust the parameters using back propagation to get closer to an optimal outcome for this multi-set training example. In this illustration a recurrent neural network is assumed but other neural network designs would also be applicable. Many such training examples are required to reach optimal outcome. Additional permutations of each training example may be created following the operational aspects discussed in connection with FIG. 4 and illustrated in FIG. 6.

In a subsequent operation, a new set of feature data 1501 and 1502 for competitors involved in a match is acquired with situational feature data about the event or match 1503 for which an outcome for an individual competitor is not known. Following the operational details presented regarding FIGS. 7, 6 and 8 a multi-set representation of the event is created with a competitor in the keystone location. The computing apparatus 1504 scales the current feature data 1503 and merges this with the individual competitor information 1501 and 1502. The neural network is loaded with trained parameter values and a feed forward algorithm is used to produce one or more outcomes, represented by 1510. Additional permutations of the multi-set may be created, and values may be computed by the neural net and averaged, or some other statistical combination may be used for additional accuracy. In this illustration, the computing apparatus has produced a set of statistical predictions for the competitor in the keystone location indicating expected performance in this match.

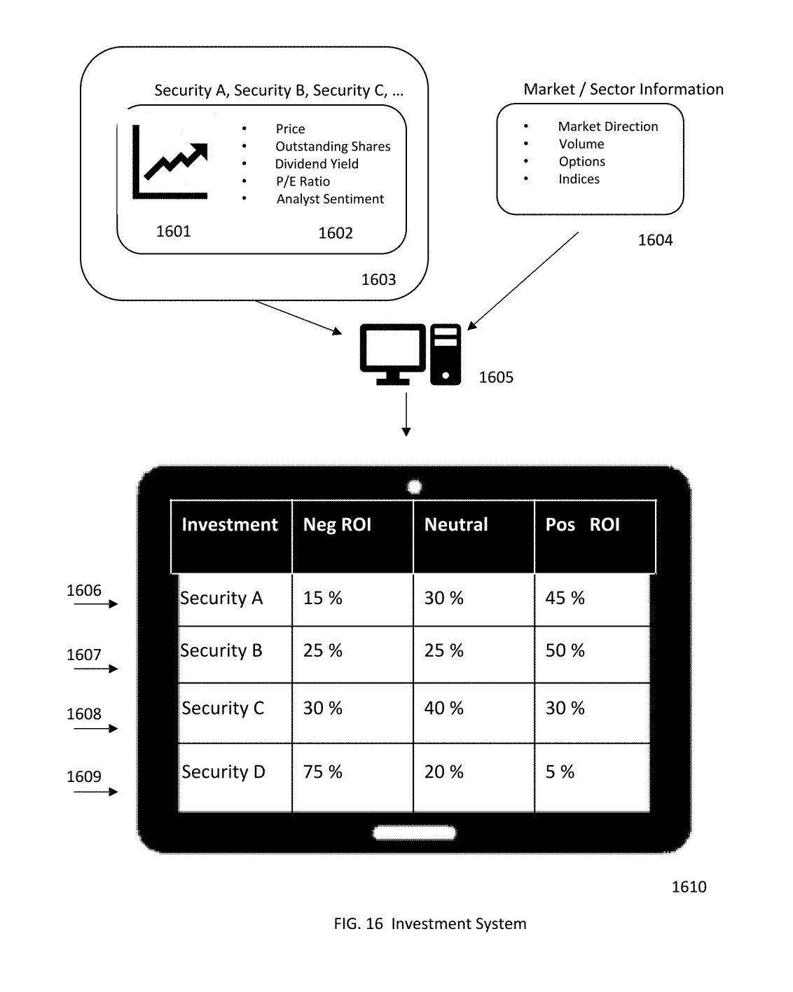

FIG. 16 illustrates an embodiment that creates a performance forecast for a set of tradable securities from a multi-set encapsulated data element with a keystone location.

A performance metric of a tradable security with respect to time, known as a chart, is stored in a computer storage medium as an image 1601. This image 1601 represents the past performance for that security relative to a metric between a time period. Also stored in a computer storage medium is information that was relevant to that security at the time the image was stored 1602. In various specific applications, this includes items such as price, outstanding shares, dividend yield, p/e ratio, analyst sentiment or some additional information. This data is combined to make a single encapsulated data type following the discussion regarding FIG. 1.

1603 represents a storage of single encapsulated data types of securities with charts 1601 and feature data 1602 which have all been stored on a computer storage medium and are available with the same timeframe to make multi-set encapsulated training examples as outlined in connection with FIG. 4 and illustrated in FIG. 5. This data is combined with situational feature data about the market for those securities 1604. Missing data are filled in as outlined in connection with FIG. 4.

As also outlined in FIG. 4, a neural network is trained based on past security performance using the computing apparatus 1605. This is accomplished by using the keystone methodology outlined in FIG. 4 and illustrated in FIG. 6. The neural network is trained with permutations that include each security in the keystone location with a known outcome (keystone location security's performance). A known outcome may be the performance of that particular security or another measure. The computing apparatus 1605 follows computer program instructions that have been created to carry out the methods described in this disclosure. The computing apparatus 1605 scales the feature data 1602 and merges this with the individual security image 1601 and then scales the situational feature data 1604 to create a multi-set encapsulated training instance with keystone location. The combination of this data with a known outcome(s) for the security in the keystone location defines a multi-set training example with keystone location. The neural network algorithms adjust the parameters using back propagation to get closer to the optimal outcome for this multi-set training example. In this illustration a time series long short-term memory recurrent neural network is assumed but other neural network designs would also be applicable. Many such training examples are required to reach optimal outcome. Additional permutations of each training example are created following the operational details presented in connection with FIG. 4 and illustrated in FIG. 6.

In a subsequent operation, at a later time, a new set of charts 1601 and feature data 1602 for a security is acquired with situational feature data about the market 1604 for which an outcome for an individual security is not yet known, but is desired to be forecasted. As discussed in connection with FIGS. 5, 6 and 8 a multi-set encapsulated data type with keystone location is created with the security of interest in the keystone location. The computing apparatus 1605 scales the feature data 1602 and merges this with the individual security image 1601 and then scales the situational feature data 1604 to create a multi-set encapsulated data instance with keystone location. The neural network is loaded with trained parameter values and a feed forward algorithm is used to produce an outcome(s) for each security (1606, 1607, 1608, 1609). Additional permutations of the multi-set may be created, and values may be computed by the neural net and averaged, or some other statistical combination may be used for additional accuracy. In this illustration, the computing apparatus has predicted the statistical likelihood of negative, neutral or positive ROI and has output that to a display, network or printing device 1610. Various other outcomes can similarly be trained and predicted with this methodology.

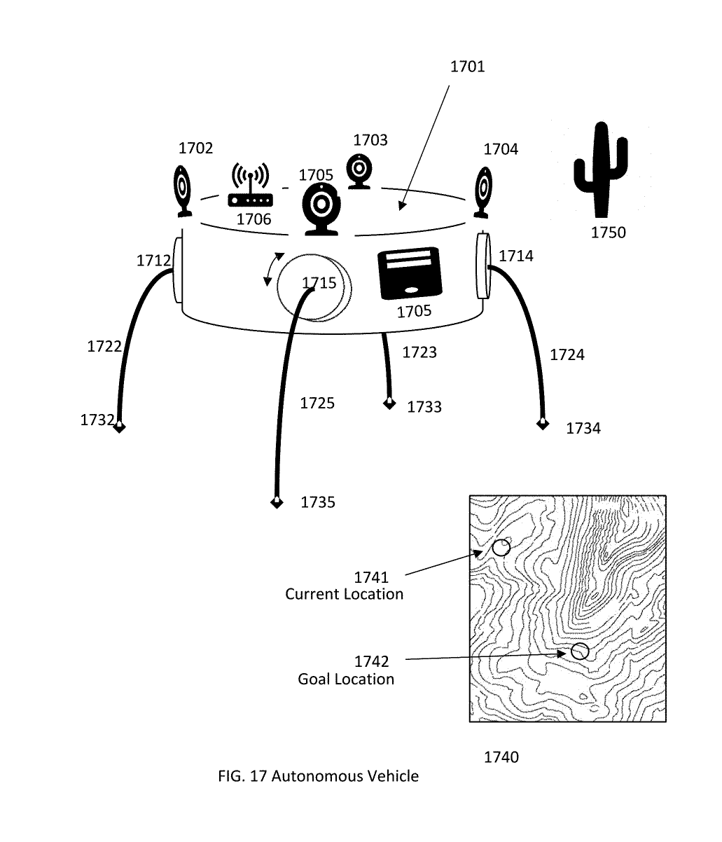

FIG. 17 illustrates an embodiment that makes motion decisions for an autonomous vehicle with multiple robotic appendages. Multi-set encapsulated data with a keystone location for each appendage is combined with situational data to activate appropriate action for each appendage.

The computing apparatus 1705 may be on the autonomous vehicle 1701 or located remotely and connected via wire or wirelessly. For this illustration the vehicle has four actuators or appendages 1722, 1723 (not visible, behind the vehicle as positioned), 1724 and 1725. For this illustration, each appendage is controlled by a stepper motor 1712, 1713 (not visible, behind the vehicle as positioned), 1714 and 1715, but could be controlled by other types of electrical or mechanical (e.g. pneumatic) motion mechanisms. The stepper motors are capable of reporting current position and rotating to a new position. For this illustration, each appendage has a pressure sensor on the end 1732, 1733, 1734 and 1735 but could contain one or more sensors reporting on a variety of information.

Each of 1702, 1703, 1704, and 1705 represents a range and depth capture mechanism associated with each corresponding appendage. For this illustration the assumption is these are LIDAR based, but other mechanisms could be used. 1750 represents an example of an obstacle that can be determined by 1702, 1703, 1704 or 1705. 1706 illustrates a GPS device capable of understanding the vehicles current position.

1740 is an elevation map with detailed coordinate information held internally in the computer memory of the computing apparatus 1705. A goal has been set 1742 to be reached by the autonomous vehicle and 1741 represents the current location of the vehicle.

In this embodiment, data relevant to each appendage is used to create a single encapsulated data type for training a neural network using the operational details provided in connection with FIG. 4. 1702, 1703, 1704, 1705 represent image data for each individual appendage, which are combined with the feature data of the appendage. 1750 represents obstacles which may be located and ranged in the image representation. The other feature data in this illustration are the sensor input for that appendage, determined by 1732, 1733, 1734 or 1735 and the stepper motor position 1712, 1713, 1714 and 1715.

As detailed in connection with FIG. 4, the single encapsulated data for all four appendages is gathered into a training set (multi set encapsulated data element). This is combined with the situational data which is provided by the current location being inserted into the map image information 1740 which already has the goal location indicated.

As also detailed in connection with FIG. 4, any missing data for the appendages can be approximated using nearest neighbor or last known value.

There are several known ways to attain the correct moves for the autonomous vehicle for training. One obvious way is to manually actuate the appendages to reach the goal. This creates correct positional adjustments for each appendage stepper motor. It is also possible to use a random algorithm of adjustments to the appendage stepper motors and record the outcome of successful and failed attempts.

A neural network is trained, as outlined in connection with FIG. 4, so as to produce the correct stepper motor changes for each time interval by the computing apparatus 1705. In this illustration a convolutional long short-term memory recurrent neural network (C-LSTM) is assumed but other neural network designs would also be applicable. This is performed by using the keystone methodology described in connection with FIG. 4 and illustrated in FIG. 6. The neural network is trained with permutations that include each appendage's encapsulated data type in the keystone location with the known correct position. The computing apparatus 1705 follows computer program instructions that have been created to carry out the methods described in this disclosure. The computing apparatus 1705 scales the feature data for each appendage (e.g. 1732, 1712 stepper position) and merges this with the individual appendage image (e.g. 1702), and then scales the situational feature data 1706, 1741, 1742 and 1740 to create a multi-set encapsulated training instance with keystone location. The combination of this data with one or more known outcomes for each stepper motor adjustment in the keystone location defines a multi-set training example with keystone location. The neural network algorithms adjust the parameters using back propagation to get closer to the optimal outcome for this multi-set training example. Many such training examples are required to reach optimal outcome. Additional permutations of each training example may be created following the discussion of FIG. 4 and as illustrated in FIG. 6.

In a subsequent operation, at a later time, the vehicle is placed in a new location 1706, with a new topographical map 1740 and goal location 1742. Corresponding to the operational details set forth for FIG. 5, FIG. 6 and FIG. 8 a multi-set encapsulated data type with keystone location is created for each appendage. The computing apparatus 1705 scales the feature data for each appendage (e.g. 1732, 1712 stepper position) and merges this with the individual appendage image (e.g. 1702) and then scales the situational feature data 1706, 1741, 1742 and 1740 to create a multi-set encapsulated instance with keystone location. The neural network is loaded with trained parameter values and a feed forward algorithm is used to produce one or more outcomes for each appendage stepper motor change (1712, 1713, 1714, 1715). Additional permutations of the multi-set may be created, and values may be computed by the neural net and averaged, or some other statistical combination may be used for additional accuracy. In this illustration, the computing apparatus has predicted the statistical likelihood of each stepper motors location of being most correct and has activated the motor to the most likely correct position. This causes the autonomous vehicle to move.

While this illustration uses an autonomous vehicle with appendages, the methods and systems disclosed can be used to facilitate autonomous robotic decisions of any type of actuation. The types of actuation need not be identical as they are in this example. For example, other types might involve wheel direction, aileron changes, motor output (e.g. speed or torque), pneumatic or electric actuators.

### Other Considerations

The disclosures herein have been provided in particular detail with respect to certain embodiments. Those of skill in the art will appreciate that other embodiments may be practiced based on these disclosures. First, the particular naming of the components and variables, capitalization of terms, the attributes, data structures, or any other programming or structural aspect is not mandatory or significant, and the mechanisms that implement an embodiment or its features may have different names, formats, or protocols. Also, the particular division of functionality between the various system components described herein is merely for purposes of example, and is not mandatory; functions performed by a single system component may instead be performed by multiple components, and functions performed by multiple components may instead performed by a single component.

Some portions of above description present the features of the disclosed embodiments in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the disclosed embodiments include process steps and instructions described herein in the form of an algorithm. It should be noted that the process steps and instructions may in many cases be implemented in hardware, firmware or software that transforms a general purpose machine (e.g., computer) into a special-purpose machine. Such process steps and instructions, when embodied in software, are in some potential embodiments capable of being downloaded to reside on and be operated from different platforms used by real time network operating systems.

The disclosed embodiments also relate to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the embodiments presented herein are not described with reference to any particular programming language. It is appreciated that a variety of programming languages may be used to implement the teachings of the present embodiments as described herein, and any references to specific languages are provided for invention of enablement and best mode of the described embodiments.

Embodiments described herein are well suited to a wide variety of computer network systems over numerous topologies. Within this field, the configuration and management of large networks comprise storage devices and computers that are communicatively coupled to dissimilar computers and storage devices over a network, such as the Internet or a private network.

Finally, it should be noted that the language used in the specification has been principally selected for readability and instructional purposes, and may not have been selected to delineate or circumscribe the inventive subject matter. Accordingly, the disclosure of the present embodiments is intended to be illustrative, but not limiting, of the scope of the invention, which is set forth in the following claims.

1. A computer-implemented method of training a deep learning neural network to undertake neural processing of a plurality of disparate data items and related disparate feature data, the method comprising:
determining format and value ranges for the plurality of disparate data items;
rescaling the feature data to correspond to the format and range values;
merging the rescaled feature data with the disparate data items to create a single encapsulated data item corresponding to the disparate data items and the disparate feature data;
combining into a training set the single encapsulated data item and a known correct output corresponding to the disparate data items and the single encapsulated data item; and
training the deep learning neural network with the training set.

2. The computer-implemented method of claim 1, wherein a plurality of single encapsulated data items are combined into a multi-set and used in assembly of the training set, and where the known correct output relates to the assembled training set.

3. The computer-implemented method of claim 1, wherein a plurality of encapsulated data items are combined into a multi-set and used in assembly of the training set in conjunction with a predefined keystone location, and where the known correct output relates to an item in the keystone location.

4. The computer-implemented method of claim 1, wherein situational information is added to the training data.

5. The computer-implemented method of claim 1, further comprising reordering a plurality of encapsulated data items into new permutations to create additional training examples.

6. A computer-implemented method of using a deep learning neural network to undertake neural processing of a plurality of disparate data items and related disparate feature data, the method comprising:
determining format and value ranges for the plurality of disparate data items;
rescaling the disparate feature data to correspond to the format and range values;
merging the rescaled disparate feature data with the disparate data items to create a single encapsulated data item corresponding to the disparate data items and the disparate feature data; and
providing the single encapsulated data item and previously determined weights and biases as inputs to the neural network in a feed forward computation mode to determine an output for downstream processing.

7. The computer-implemented method of claim 6, wherein the output for downstream processing comprises at least one of: predictive analysis, classification, feature detection, and ranking.

8. The computer-implemented method of claim 6, further comprising using a plurality of encapsulated data items to assemble a training set, reordering the training set to create additional training set permutations, and using the training set and the training set permutations to determine the weights and biases.

9. The computer-implemented method of claim 6, further comprising using a plurality of encapsulated data items to assemble a training set; calculating, from other training data, proxy training data corresponding to missing data; and using the proxy training data and the training set to determine the weights and biases.

10. The computer-implemented method of claim 6, wherein the neural processing is performed on a plurality of encapsulated data items and the output is compared to known outcomes to calculate a measure of forecast skill.

11. A deep learning neural network apparatus for neural processing of a plurality of disparate data items and related disparate feature data, the apparatus comprising:
an input data processor configured for storage and delivery to a merge processor of plural disparate data elements, the plural disparate data elements defining plural ranges;
a rescaling processor configured to accept as input the ranges from a range repository and plural disparate data feature elements from a feature processor, the plural disparate data feature elements corresponding to the disparate data elements, the rescaling processor being configured to rescale the disparate data feature elements to correspond with the disparate data elements;
a merge processor configured to accept as input the disparate data elements from the input data processor and the rescaled disparate data feature elements from the rescaling processor and to produce therefrom a single encapsulated data type representative of the plural disparate data feature elements and the disparate data feature elements;
a neural network preprocessor configured to accept as input the single encapsulated data type from the merge processor and a set of trained neural net parameter values from a parameter repository, the neural network preprocessor further configured to produce therefrom neural network weights, biases, and input values; and
a neural network processor operatively connected to the neural network preprocessor and configured to accept as input the weights, biases, and input values, and perform multilayer feed forward computational processing, producing therefrom a neural network result.

12. The apparatus of claim 11, wherein the disparate data elements include image elements of a first data type, video elements of a second data type, and sound elements of a third data type, and the ranges include an image range, a video range, and a sound range.

13. The apparatus of claim 11, further comprising an output processor operatively connected to the neural network processor, the output processor receiving the neural network result and initiating downstream processing.

14. The apparatus of claim 11, further comprising a training subsystem, the training subsystem comprising:
a known data repository configured to store a plurality of known disparate data elements;
a known feature repository configured to store a plurality of known disparate feature data elements corresponding to the known plural disparate data elements;
a known outcome repository storing known outcomes corresponding to the known disparate data elements and the known disparate situational data elements;
a missing data replacement processor configured to create values for any missing feature data;
a training set creation processor configured to accept as input at least one single encapsulated data training item in combination with situational information about the at least one single encapsulated data training item and known outcomes to create training set examples; and
a neural network training processor configured to accept as input the training examples and known outcomes, to perform back propagation training processing to determine optimal weights and biases, and to store the optimal weights and biases in a training neural network parameter values subsystem.

15. The apparatus of claim 14, further comprising a shuffle processor configured to accept as input the training result, shuffle one or more of the encapsulated samples, and re-submit the shuffled training result to the neural network training processor for iterative training.

16. The apparatus of claim 11, wherein the input data processor further comprises a medical picture archiving and communication system configured to store output from medical image modalities and wherein the feature processor comprises a medical records system configured to provide data from individual patient episodes of care.

17. The apparatus of claim 11 wherein the input data processor takes as input digitized representations of weather and wherein the feature processor is configured to provide location specific weather information.

18. The apparatus of claim 11 wherein the input data processor takes as input radiographic images of contents of parcels and wherein the feature processor is configured to provide quantitative and qualitative data about the parcels.

19. The apparatus of claim 11, wherein the input data processor takes as input information about competitors, the neural network parameter values correspond to information about the competitors in past competitive matchups, and the output processor is configured to generate performance predictions for the competitors

20. The apparatus of claim 11, wherein the plural disparate data elements are provided by plural disparate subsystems of an autonomous vehicle, and the output processor is configured to generate robotic movements of the autonomous vehicle.
